(19) United States
(12) Patent Application Publication
(10) Pub. No.: US 2023/0118002 A1
(43) Pub. Date: Apr. 20, 2023

(54) DRIVING ASSISTANCE APPARATUS AND NON-TRANSITORY COMPUTER READABLE MEDIUM

(71) Applicant: SUBARU CORPORATION, Tokyo (JP)

(72) Inventors: Hideyuki TAKAO, Tokyo (JP); Riku KATO, Tokyo (JP); Ryuichi SUMIKAWA, Tokyo (JP); Yosuke TAKEBAYASHI, Tokyo (JP); Yu YOSHIDA, Tokyo (JP)

(21) Appl. No.: 17/942,463

(22) Filed: Sep. 12, 2022

(30) Foreign Application Priority Data
Sep. 28, 2021 (JP) 2021-157628

(51) Int. Cl. G08G 1/0967; G08G 1/01

(52) U.S. Cl. CPC G08G 1/0967; G08G 1/0133

(57) ABSTRACT

A driving assistance apparatus assists driving of a first vehicle. The driving assistance apparatus includes at least one processor and at least one memory communicably coupled to the at least one processor. The at least one processor acquires information on a traveling state of the first vehicle and information on a surrounding environment of the first vehicle, determines a factor that provokes tailgating by comparing the information on the traveling state of the first vehicle with accumulated data on traveling states of second vehicles in a driving condition belonging to the same category as a driving condition of the first vehicle, and presents feedback information about a driving action of a driver who drives the first vehicle on the basis of the factor that provokes the tailgating.

### CROSS-REFERENCE TO RELATED APPLICATIONS

The present application claims priority from Japanese Patent Application No. 2021-157628 filed on Sep. 28, 2021, the entire contents of which are hereby incorporated by reference.

### BACKGROUND

The technology relates to a driving assistance apparatus that assists a driver in driving a vehicle and a non-transitory computer readable medium that records a computer program for assisting a driver in driving a vehicle.

Tailgating is known as a dangerous driving action. Japanese Unexamined Patent Application Publication (JP-A) No. 2006-205773 discloses a driving assistance apparatus that detects tailgating to prevent accidents or troubles with a vehicle traveling behind. For example, the driving assistance apparatus disclosed in JP-A No. 2006-205773 determines the condition of a surrounding environment around an own vehicle on the basis of outputs from a navigator, a road information collector, and a camera. The driving assistance apparatus disclosed in JP-A No. 2006-205773 also determines the state of the own vehicle on the basis of outputs from a speed sensor, an acceleration sensor, a camera, a lighting system, and a vehicle control system. The driving assistance apparatus disclosed in JP-A No. 2006-205773 also determines the states of another vehicle on the basis of outputs from a camera, an inter-vehicle communicator, and a radar. The driving assistance apparatus disclosed in JP-A No. 2006-205773 calculates the danger level of the tailgating on the basis of the condition of the surrounding environment, the state of the own vehicle, and the state of the other vehicle, and executes notification control and operation control on the basis of the results of the calculation.

JP-A No. 2021-33529 discloses a driving assistance apparatus that reduces occurrence of tailgating. For example, the driving assistance apparatus disclosed in JP-A No. 2021-33529 acquires traveling information on the own vehicle, determines whether the own vehicle is traveling in a manner likely to be tailgated by another vehicle on the basis of the traveling information, and executes notification control and traveling control on the basis of the results of the determination.

### SUMMARY

An aspect of the technology provides a driving assistance apparatus configured to assist driving of a first vehicle. The driving assistance apparatus includes at least one processor and at least one memory communicably coupled to the at least one processor. The at least one processor is configured to acquire information on a traveling state of the first vehicle and information on a surrounding environment of the first vehicle, determine a factor that provokes tailgating by comparing the information on the traveling state of the first vehicle with accumulated data on traveling states of second vehicles in a driving condition belonging to the same category as a driving condition of the first vehicle, and present feedback information about a driving action of a driver who drives the first vehicle on the basis of the factor that provokes the tailgating.

An aspect of the technology provides a non-transitory computer readable medium containing a computer program to be adapted to a driving assistance apparatus configured to assist driving of a first vehicle. The computer program causes, when executed by at least one processor, the at least one processor to implement a method including: acquiring information on a traveling state of the first vehicle and information on a surrounding environment of the first vehicle; determine a factor that provokes tailgating by comparing the information on the traveling state of the first vehicle with accumulated data on traveling states of a plurality of second vehicles in a driving condition belonging to the same category as a driving condition of the first vehicle; and presenting feedback information about a driving action of a driver who drives the first vehicle on the basis of the factor that provokes the tailgating.

### BRIEF DESCRIPTION OF THE DRAWINGS

The accompanying drawings are included to provide a further understanding of the technology and are incorporated in and constitute a part of this specification. The drawings illustrate example embodiments and, together with the specification, serve to explain the principles of the technology.

FIG. 1 is a schematic diagram of a configuration example of a vehicle including a driving assistance apparatus according to one example embodiment of the technology.

FIG. 2 is a block diagram of a configuration example of the driving assistance apparatus according to one example embodiment of the technology.

FIG. 3 is a flowchart of a tailgating determination process performed by the driving assistance apparatus according to one example embodiment of the technology.

FIG. 4 is an explanatory diagram of an exemplary display image of the results of a questionnaire.

FIG. 5 is a flowchart of an exemplary routine of a processing operation performed by the driving assistance apparatus according to one example embodiment of the technology.

FIG. 6 is a flowchart of a mid-driving process performed by the driving assistance apparatus according to one example embodiment of the technology.

FIG. 7 is a flowchart of a driving action correction process performed by the driving assistance apparatus according to one example embodiment of the technology.

FIG. 8 is a flowchart of an example of a tailgating factor determination process according to one example embodiment of the technology.

FIG. 9 is a flowchart of another example of the tailgating factor determination process according to one example embodiment of the technology.

FIG. 10 is an explanatory diagram for describing examples of the results of comparison between driving actions.

FIG. 11 is a flowchart of a post-driving process performed by the driving assistance apparatus according to one example embodiment of the technology.

FIG. 12 is an explanatory diagram of an layout example of a feedback screen.

FIG. 13 is an explanatory diagram of examples of moving image patterns to be replayed.

FIG. 14 is an explanatory diagram of other examples of the moving image patterns to be replayed.

FIG. 15 is an explanatory diagram of still other examples of the moving image patterns to be replayed.

FIG. 16 is a flowchart of a post-driving process performed by the driving assistance apparatus according to one example embodiment of the technology.

FIG. 17 is an explanatory diagram for describing data on the frequency of occurrence of dangerous driving in a traveling area.

FIG. 18 is an explanatory diagram for describing data on an average cruising speed in a traveling area.

### DETAILED DESCRIPTION

The driving assistance apparatuses disclosed in JP-A Nos. 2006-205773 and 2021-33529 fail to solve a fundamental problem because they do not present the driver of an own vehicle the factor that provokes tailgating and the way to improve his/her driving actions. For example, in a case where a driver with a low driving skill makes drivers of other vehicles traveling around feel anxiety or stress, the driving assistance apparatuses disclosed in JP-A Nos. 2006-205773 and 2021-33529 perform notification processing or traveling control to allow the driver of the own vehicle to avoid danger just at the time of occurrence of the danger; however, these driving assistance apparatuses fail to recognize the factor that provokes tailgating and the way to improve driving actions. This fails to prevent the driver of the own vehicle from repeating the same driving action, leaving the possibility of being tailgated by the other vehicle traveling around the own vehicle.

It is desirable to provide a driving assistance apparatus that presents the driver of the own vehicle the factor that makes the drivers of the other vehicles traveling around feel anxiety or stress with the driving action of the driver of the own vehicle and the way to improve the driving action in order to enhance the driving skill of the driver of the own vehicle, and a computer readable medium containing a computer program for presenting the driver of the own vehicle the factor that makes the drivers of the other vehicles traveling around feel anxiety or stress with the driving action of the driver of the own vehicle and the way to improve the driving action in order to enhance the driving skill of the driver of the own vehicle.

In the following, some example embodiments of the technology are described in detail with reference to the accompanying drawings. Note that the following description is directed to illustrative examples of the disclosure and is not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the disclosure are optional and may be provided on an asneeded basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the technology are unillustrated in the drawings.

### 1. Overall Configuration of Vehicle

First, an overall configuration example of a driving assistance apparatus according to an example embodiment of the technology is described.

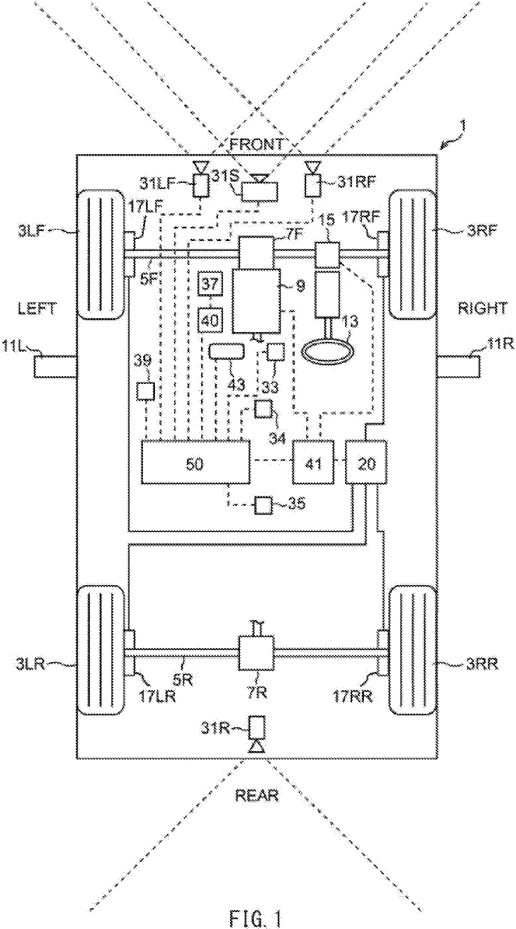

FIG. 1 schematically illustrates a configuration example of an own vehicle 1 including a driving assistance apparatus 50 according to an example embodiment of the technology. In one embodiment, the own vehicle 1 may serve as a “first vehicle”. The own vehicle 1 illustrated in FIG. 1 may be a four-wheel-drive vehicle that transmits driving torque generated and outputted from a driving power source 9 to a left-front wheel 3LF, a right-front wheel 3RF, a left-rear wheel 3LR, and a right-rear wheel 3RR. Hereinafter, these wheels are collectively referred to as wheels 3 unless a specific distinction between them has to be made. The driving power source 9 may be a drive motor or an internal-combustion engine such as a gasoline engine or a diesel engine, or may include both an internal-combustion engine and a drive motor.

Alternatively, the own vehicle 1 may be an electric vehicle including, for example, a front-wheel drive motor and a rear-wheel drive motor. Still alternatively, the own vehicle 1 may be an electric vehicle including drive motors for the respective wheels 3. In a case where the own vehicle 1 is an electric vehicle or a hybrid electric vehicle, the own vehicle 1 may include a secondary battery that stores electric power to be supplied to the drive motors, a motor that generates electric power to be stored in the battery, and a power generator, such as a fuel cell.

The own vehicle 1 may include the driving power source 9, an electric steering device 15, and a brake hydraulic controller 20 as devices for controlling the traveling of the own vehicle 1. The driving power source 9 may output driving torque to be transmitted via an unillustrated transmission and a front-wheel differential mechanism 7F to a front-wheel drive shaft 5F, and driving torque to be transmitted via the transmission and a rear-wheel differential mechanism 7R to a rear-wheel drive shaft 5R. The driving power source 9 and the transmission may be driven under the control of a vehicle control apparatus 41. The vehicle control apparatus 41 may include one or more electronic control units (ECUs).

The front-wheel drive shaft 5F may be provided with the electric steering device 15. The electric steering device 15 may include an electric motor and a gear mechanism that are not illustrated. The electric steering device 15 may adjust steering angles of the left-front wheel 3LF and the right-front wheel 3RF under the control of the vehicle control apparatus 41. During manual driving, the vehicle control apparatus 41 may control the electric steering device 15 on the basis of the steering angle of a steering wheel 13 operated by a driver who drives the own vehicle 1 (herein after the driver of the own vehicle 1). During automatic driving, the vehicle control apparatus 41 may control the electric steering device 15 on the basis of a target steering angle set by the driving assistance apparatus 50.

The own vehicle 1 has a brake system, which may be a hydraulic pressure brake system. The brake hydraulic controller 20 may adjust hydraulic pressure to be supplied to a left-front brake caliper 17LF of the left-front wheel 3LF, a right-front brake caliper 17RF of the right-front wheel 3RF, a left-rear caliper 17LR of the left-rear wheel 3LR, and a right-rear caliper 17RR of the right-rear wheel 3RR to generate braking force. Hereinafter, the left-front brake caliper 17LF, the right-front brake caliper 17RF, the left-rear brake caliper 17LR, and the right-rear caliper 17RR may be collectively referred to as “brake calipers 17” unless a specific distinction between them has to be made. The brake hydraulic controller 20 may be driven under the control of the vehicle control apparatus 41. In a case where the own vehicle 1 is an electric vehicle or a hybrid electric vehicle, the brake hydraulic controller 20 may be used together with regenerative braking by a drive motor.

The vehicle control apparatus 41 may include one or more electronic control devices that control driving of the driving power source 19 that outputs driving torque of the own vehicle 1, the electric steering device 15 that controls the angle of the steering wheel 13 or the angles of the steered wheels, and the brake hydraulic controller 20 that controls the braking force of the own vehicle 1. The vehicle control apparatus 41 may further control driving of the transmission that converts an output from the driving power source 9 and transmits the converted output to the wheels 3. The vehicle control apparatus 41 is configured to receive information from the driving assistance apparatus 50 to achieve automatic driving control of the own vehicle 1. During manual driving of the own vehicle 1, the vehicle control apparatus 41 may acquire information on the amount of a driving operation performed by the driver, to thereby control the driving power source 9 that outputs driving torque of the own vehicle 1, the electric steering device 15 that controls the angle of the steering wheel 13 or the angles of the steered wheels, and brake hydraulic controller 20 that controls the braking force of the own vehicle 1.

The own vehicle 1 may further include front imaging cameras 31LF and 31RF, a rear imaging camera 31R, a light detection and ranging (LiDAR) 31S, a vehicle interior camera 33, a biosensor 34, a vehicle state sensor 35, a global positioning system (GPS) sensor 37, an inter-vehicle communicator 39, a navigation system 40, and a human-machine interface (HMI) 43.

The front imaging cameras 31LF and 31RF, the rear imaging camera 31R, and the LiDAR 31S may constitute a surrounding environment sensor of the own vehicle 1. The surrounding environment sensor may acquire information on the surrounding environment of the own vehicle 1. The front imaging cameras 31LF and 31RF and the rear imaging camera 31R may capture images of the areas in front of and behind the own vehicle 1 to generate image data. The front imaging cameras 31LF and 31RF and the rear imaging camera 31R may include imaging devices such as charged-coupled devices (CCD) or complementary metal-oxide-semiconductors (CMOS). The front imaging cameras 31LF and 31RF and the rear imaging camera 31R may transmit the generated image data to the driving assistance apparatus 50.

The front imaging cameras 31LF and 31RF of the own vehicle 1 illustrated in FIG. 1 may be a pair of cameras serving as a stereo camera, and the rear imaging camera 31R may be a monocular camera. However, these cameras may each be a stereo camera or a monocular camera. The own vehicle 1 may further include cameras located on, for example, side mirrors 11L and 11R in addition to the front imaging cameras 31LF and 31RF and the rear imaging camera 31R. The cameras located on the side mirrors 11L and 11R may capture images of areas on a left-rear side and a right-rear side of the own vehicle 1.

The LiDAR 31S may transmit an optical wave and receive a reflective wave of the optical wave to detect a distance between two objects on the basis of time from the transmission of the optical wave to the reception of the reflective wave. The LiDAR 31S may send the detection data to the driving assistance apparatus 50. The surrounding environment sensor of the own vehicle 1 that acquires the surrounding environment information may include one or both of a radar sensor and an ultrasonic sensor in place of the LiDAR 31S or in addition to the LiDAR 31S. For example, the radar sensor may be a millimeter-wave radar.

The vehicle interior camera 33 may include one or more sensors that acquire information on the driver of the own vehicle 1. The vehicle interior camera 33 may include an imaging device such as a CCD or a CMOS. The vehicle interior camera 33 may capture an image of the interior of the own vehicle 1 to generate image data. The vehicle interior camera 33 may send the generated image data to the driving assistance apparatus 50. In the example embodiment, the vehicle interior camera 33 may be located so as to capture an image of the driver of the own vehicle 1. One or more vehicle interior cameras 33 may be mounted on the own vehicle 1.

The biosensor 34 may acquire biological information on the driver of the own vehicle 1 and may send the detection data to the driving assistance apparatus 50. The biosensor 34 may be, for example, a radio-wave Doppler sensor that detects the heart rate of the driver, or a non-wearable pulse sensor that detects the pulse rate of the driver. Alternatively, the biosensor 34 may be a pair of electrodes embedded in the steering wheel 13 to measure the heart rate or the electrocardiogram of the driver. Still alternatively, the biosensor 34 may be a pressure instrument embedded in a driver’s seat to measure the distribution of the pressure on the driver’s seat while the driver is seated in the driver’s seat. Still alternatively, the biosensor 34 may be a displacement sensor that detects the displacement of the position of the seatbelt to measure the heart rate or the breathing of the driver. Yet still alternatively, the biosensor 34 may be a time of flight (TOG) sensor that acquires information on the position of the driver, or a thermographic sensor that measures the skin surface temperature of the driver.

The biosensor 34 may be a wearable sensor to be mounted on the driver to acquire biological information on the driver. Examples of the wearable biosensor 34 may include watch-shaped devices, head-mounted devices, and arm-mounted devices. These wearable devices may detect biological information on the driver, such as the heart rate, the pulse rate, the blood pressure, and the body temperature of the driver. The wearable biosensor 34 may be coupled to the driving assistance apparatus 50 directly or via a controller area network (CAN) or a local interconnect network (LIN). Alternatively, the wearable biosensor 34 may be communicable with the driving assistance apparatus 50 via wireless communication such as Bluetooth (registered trademark), near field communication (NFC), Wireless Fidelity (Wi-Fi), or a local area network (LAN).

The vehicle state sensor 35 may include one or more sensors that detect operating states and behaviors of the own vehicle 1. For example, the vehicle state sensor 35 may include at least one of a steering angle sensor, an accelerator position sensor, a brake stroke sensor, a brake pressure sensor, or an engine revolution sensor to detect an operating state of the own vehicle 1, such as the angle of the steering wheel 13 or the angles of the steered wheels, an accelerator position, the amount of braking operation, or the number of revolutions of the engine. The vehicle state sensor 35 may include, for example, at least one of a vehicle speed sensor, an acceleration sensor, or an angular rate sensor to detect a behavior of the own vehicle 1, such as a vehicle speed, a frontward or backward acceleration rate, a lateral acceleration rate, or a a yaw rate. The vehicle state sensor 35 may include a sensor that detects an operation of a direction indicator to detect an operating state of the direction indicator. The vehicle state sensor 35 may include a sensor that detects a tilting state of the own vehicle 1 to detect the slope of a road. The vehicle state sensor 35 may send a sensor signal including the detected information to the driving assistance apparatus 50.

The inter-vehicle communicator 39 may be an interface that establishes communication between the own vehicle 1 and another vehicle traveling around the own vehicle 1.

The navigation system 40 may be a known navigation system that determines a traveling route to a destination set by an occupant of the own vehicle 1, and notifies the driver of the traveling route. The navigation system 40 may be coupled to the GPS sensor 37. The navigation system 40 may receive satellite signals from the GPS satellites via the GPS sensor 37 and may acquire information on a position of the own vehicle 1 on map data. In place of the GPS sensor 37, an antenna may be used to receive satellite signals for identifying the position of the own vehicle 1 from another satellite system.

The HMI 43 may be driven by the driving assistance apparatus 50. The HMI 43 may present various kinds of information to the driver by displaying images or outputting sounds or voices, for example. The HMI 43 may include a display disposed in an instrument panel and a speaker disposed in the own vehicle 1. The display may also serve as a display for the navigation system 40. The HMI 43 may further include a head-up display that displays an image on the front windshield of the own vehicle 1.

### 2. Driving Assistance Apparatus

The driving assistance apparatus 50 according to an example embodiment of the technology will now be described in detail.

### 2-1. Configuration Example

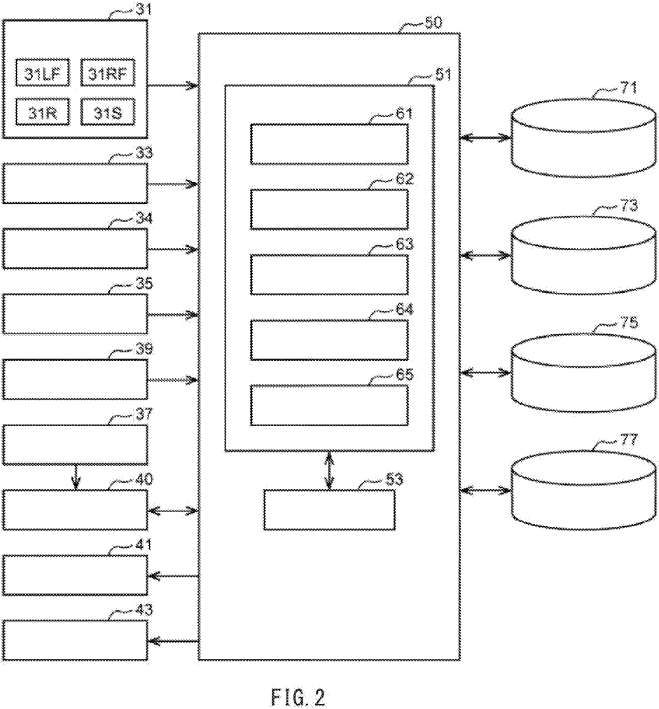

FIG. 2 is a block diagram illustrating a configuration example of the driving assistance apparatus 50 according to an example embodiment of the technology. The surrounding environment sensor 31, the vehicle interior camera 33, the biosensor 34, and the vehicle state sensor 35 may be coupled to the driving assistance apparatus 50 via dedicated lines or a communication network such as a CAN or a LIN. Further, the inter-vehicle communicator 39, the navigation system 40, the vehicle control apparatus 41, and the HMI 43 may be coupled to the driving assistance apparatus 50 via dedicated lines or a communication network such as a CAN or a LIN. The driving assistance apparatus 50 should not be limited to an electronic control apparatus mounted on the own vehicle 1; alternatively, the driving assistance apparatus 50 may be a terminal device such as a smartphone or a wearable device.

The driving assistance apparatus 50 includes one or more processors and one or more memories communicably coupled to the one or more processors. For example, the one or more processors may be central processing units (CPUs), and the one or more memories may be random access memories (RAMs) or read only memories (ROMs). The driving assistance apparatus 50 serves as an apparatus that assists driving of the own vehicle 1 when a computer program is executed by the one or more processors such as CPUs. The computer program may be a program that causes the one or more processors to execute operations (described below) to be performed by the driving assistance apparatus 50. The computer program to be executed by the one or more processors may be stored in a recording medium that serves as a memory 53 of the driving assistance apparatus 50, a recording medium accommodated in the driving assistance apparatus 50, or any recording medium disposed outside the driving assistance apparatus 50.

Examples of the recording medium that stores the computer program may include a magnetic medium, an optical recording medium, a magneto-optical medium, a memory, a flash memory, and other media configured to store programs.

Examples of the magnetic medium may include a hard disk, a floppy disk, and a magnetic tape. Examples of the optical recording medium may include a compact disc read only memory (CD-ROM), a digital versatile disk (DVD), and a Blu-ray (registered trademark). Examples of the magneto-optical medium may include a floptical disk. Examples of the memory may include a random access memory (RAM) and a read only memory (ROM). Examples of the flash memory may include a universal serial bus (USB) memory and a solid state drive (SSD).

The driving assistance apparatus 50 includes a processor 51 and the memory 53. The processor 51 may include one or more processors such as CPUs. A part or the entirety of the processor 51 may be configured by updatable software such as firmware, or may be a program module executed in response to a command from the CPU, for example. The memory 53 may be a memory or a recording medium such as a RAM or a ROM. Note that the memory 53 should not be limited to a specific number and a specific kind. The memory 53 may store computer programs to be executed by the processor 51, various parameters to be used in calculation processing, detection data, and the results of the calculation.

### 2-2. Database

The driving assistance apparatus 50 may be communicably coupled to a driving database 71, a tailgating case database 73, a normal driving database 75, and a driver database 77. Each of the driving database 71, the tailgating case database 73, the normal driving database 75, and the driver database 77 may be a memory such as a RAM, or an updatable recording medium such as a hard disk drive (HDD), a compact disk (CD), a digital versatile disk (DVD), a solid state drive (SSD), a USB flash, or a storage device. Note that the recording medium should not be limited to a specific kind.

One or all of the driving database 71, the tailgating case database 73, the normal driving database 75, and the driver database 77 may be mounted in the own vehicle 1 or may be stored in a server communicable with the driving assistance apparatus 50 via wireless communication such as mobile communication. Alternatively, some or all of the databases may be configured as a single database.

### Driving Database

The driving database 71 may store information on traveling states (hereinafter also referred to as traveling state information) of the own vehicle 1. The traveling state information of the own vehicle 1 stored in the driving database 71 may include, for example, vehicle behavior data, driving action data, and surrounding environment data. The vehicle behavior data may include, for example, data on a vehicle speed, a frontward acceleration rate, a backward acceleration rate, a lateral acceleration rate, a frontward jerk, a backward jerk, and a lateral jerk. The driving action data may include, for example, data on an accelerator operation amount, a braking operation amount, and a steering angle. The vehicle behavior data and the driving action data may be generated on the basis of the information on the behaviors and the operating states of the own vehicle 1 detected by the vehicle state sensor 35.

The surrounding environment data may include at least one of: data on a road on which the own vehicle 1 is traveling (e.g., data on the curved shape, the slope, the traveling lanes, or the width of the road); data on the positional relationship with an obstacle located around the own vehicle 1 or another vehicle (e.g., data on a relative speed, a relative position, or a relative distance); and traffic data on the environment in which the own vehicle 1 is traveling (e.g., data on a speed limit or a traveling time zone). The surrounding environment data may include at least one of information on a traveling position of the own vehicle 1 and information on a section or region in which the own vehicle 1 is traveling (hereinafter collectively referred to as “traveling area information”). The surrounding environment data may be generated on the basis of the information acquired by the surrounding environment sensor 31 and the position information acquired via the GPS sensor 37 and stored.

All of the pieces of the traveling state information on the own vehicle 1 collected while the own vehicle 1 is traveling may be stored in the driving database 71. Alternatively, some pieces of the traveling state information acquired when a tailgating determination unit 63 (described below) determines that the own vehicle 1 is tailgated by another vehicle may be stored in the driving database 71. Among the pieces of the traveling state information on the own vehicle 1 to be stored in the driving database 71, the pieces of the traveling state information acquired when the tailgating determination unit 63 determines that the own vehicle 1 is tailgated by another vehicle may include data on the type of the tailgating together with a tailgated driving flag.

### Tailgating Case Database

The tailgating case database 73 may store traveling state information on traveling states at the occurrences of tailgating. Like the traveling state information stored in the driving database 71, the traveling state information stored in the tailgating case database 73 may include, for example, vehicle behavior data, driving action data, and surrounding environment data. The traveling state information stored in the tailgating case database 73 may include collected data about cases in which drivers in other vehicles felt anxiety, anger, or stress about a vehicle and collected data about cases in which a vehicle was tailgated by another vehicle. Hereinafter, these cases may be referred to as tailgating events.

The data on the tailgating events may include information on a traveling state of a vehicle that made drivers in other vehicles traveling around feel anxiety, anger, or stress or information on a traveling state of a vehicle tailgated by another vehicle (hereinafter, such a vehicle is collectively referred to as a tailgated vehicle), and information on a traveling state of a vehicle of which driver felt anxiety, anger, or stress about another vehicle traveling around or information on a traveling state of a vehicle tailgated another vehicle (hereinafter, such a vehicle is collectively referred to as a tailgating vehicle). The traveling state information stored in the tailgating case database 73 may include the traveling state information on the tailgating vehicle and the traveling state information on the tailgated vehicle acquired in a predetermined time before and after the occurrence of the tailgating event.

These pieces of the data on the tailgating events stored in the tailgating case database 73 may be classified according to tailgating scenes set on the basis of the vehicle behavior data, the driving action data, and the surrounding environment data. For example, the tailgating scenes may be classified into two driving scenes: a driving scene in which two or more vehicles travel at an inter-vehicle distance, and a driving scene in which two or more vehicles travel side by side on a road with two or more lanes at speeds considerably different from each other. That is, the tailgating scenes may be associated with respective factors that provoke tailgating.

### Normal Driving Database

The normal driving database 75 may store traveling state information on traveling states of the own vehicle 1 (first vehicle) not being tailgated. Like the traveling state information stored in the driving database 71, the traveling state information stored in the normal driving database 75 may include, for example, vehicle behavior data, driving action data, and surrounding environment data. The traveling state information stored in the normal driving database 75 may include data collected by the driving assistance apparatus 50 of the own vehicle 1 (the first vehicle) and data collected by the vehicle driving assistance apparatuses 50 of a plurality of second vehicles other than the own vehicle 1. The traveling state information stored in the normal driving database 75 may also include data on model driving generated in advance. Alternatively, the traveling state information stored in the normal driving database 75 may include all of these pieces of data.

### Driver Database

The driver database 77 may store information on drivers. In this example embodiment, the driver database 77 may store data on the feature amounts extracted from face images of respective drivers, and identification data associated with the respective pieces of data on the feature amounts. The identification data should not be limited to particular data; the identification data may be, for example, text data, numeric data, or symbolic data. The driver database 77 may further store information on tailgating characteristics of the respective drivers. The information on tailgating characteristics may be stored in association with the identification data of the drivers.

### 2-3. Functional Configuration of Processor

The processor 51 of the driving assistance apparatus 50 may acquire the traveling state information on the own vehicle 1, the traveling state information on other vehicles traveling around the own vehicle 1, the information on relative positions between the own vehicle 1 and the other vehicles, and the information on tailgating characteristics of the drivers of the other vehicles. On the basis of the information acquired, the processor 51 may execute a process for determining whether the own vehicle 1 has a possibility of being tailgated by another vehicle.

As illustrated in FIG. 2, the processor 51 of the driving assistance apparatus 50 may include a driver determination unit 61, an acquisition unit 62, a tailgating determination unit 63, a tailgating factor determination unit 64, and a feedback presentation unit 65. These units may be functions to be implemented when the processors such as CPUs execute computer programs. Some or all of these units may be analog circuits.

In the following, the functions of these units of the processor 51 are briefly described, following which processing operations of the processor 51 are described in detail.

### Driver Determination Unit

The driver determination unit 61 may execute a process for identifying the driver of the own vehicle 1 including the driving assistance apparatus 50 on the basis of the image data received from the vehicle interior camera 33. Alternatively, the driver determination unit 61 may identify the driver of the own vehicle 1 on the basis of information inputted by the driver or any occupant of the own vehicle 1 with an input device, such as a touch panel.

### Acquisition Unit

The acquisition unit 62 may execute a process for acquiring various pieces of information on the own vehicle 1 and the other vehicles. For example, the acquisition unit 62 may acquire the traveling state information on the own vehicle 1, the traveling state information on the other vehicles, the information on a traveling position of the own vehicle 1, such as a traveling lane on which the own vehicle 1 is traveling, the information on relative positions between the own vehicle 1 and the other vehicles, and the surrounding environment information on the own vehicle 1. The acquisition unit 62 may also acquire the information on the driver of another vehicle detected. For example, the acquisition unit 62 may acquire information on the feeling of the driver of the other vehicle and information on the tailgating characteristic of the driver of the other vehicle. The acquisition unit 62 may store the acquired information in the memory 53 as chronological data.

On the basis of the information on tailgating characteristics, the possibility that the respective drivers will tailgate a vehicle may be estimated. The information on tailgating characteristics may include, for example, histories of past tailgating or dangerous driving performed by the respective drivers. The information on tailgating characteristics may further include data on accelerating operations, decelerating operations, steering operations, passing operations, or high beam light operations performed within a predetermined time. These pieces of data may be collected and stored by the processors mounted on the respective vehicles while the drivers are driving the respective vehicles. The occurrence of tailgating or dangerous driving may be detected by a known determination technology. The possibility that the respective drivers will tailgate a vehicle may be estimated to be higher as the number of acceleration or deceleration operations or steering operations increases or as the number of passing operations or high beam light operations within a predetermined time increases.

The information on the tailgating characteristics of the drivers may further include information about the results of questionnaires collected from the drivers and stored in the control apparatus in advance. The information on the results of questionnaires may include, for example, data on the frequency of feeling frustrated while driving, actions when feeling frustrated (honking the horn, passing, yelling, etc.), and factors that made the drivers feel frustrated.

The acquisition unit 62 may acquire identification information for identifying the driver of another vehicle and extract the information on the tailgating characteristic of the driver from the data stored in the driver database 77. For example, the acquisition unit 62 may identify the driver of another vehicle by extracting the facial feature amount of the driver of the other vehicle from detection data transmitted from the surrounding environment sensor 31 and referring to the driver database 77. Alternatively, the acquisition unit 62 may identify the numbers on the license plate of the other vehicle on the basis of the image data transmitted from the surrounding environment sensor 31 and identify the driver of the other vehicle on the basis of the numbers identified. For example, data associating the license plate number with a corresponding driver may be stored in the driver database 77 or may be acquired from metadata accessible via mobile communication, for example. Alternatively, the acquisition unit 62 may acquire the identification information for identifying the driver of the other vehicle via inter-vehicle communication.

### Tailgating Determination Unit

The tailgating determination unit 63 may execute a process for determining whether the own vehicle 1 has a possibility of being tailgated by another vehicle on the basis of the traveling state information on the own vehicle 1, the traveling state information on the other vehicle, the information on a relative position between the own vehicle 1 and the other vehicle, and the information on the tailgating characteristic of the driver of the other vehicle. In this example embodiment, the tailgating determination unit 63 may generate an expression for the determination on the basis of the traveling state information on the own vehicle 1, the traveling state information on the other vehicle, the information on the relative position between the own vehicle 1 and the other vehicle, and the information on the tailgating characteristic of the driver of the other vehicle, and determine whether the own vehicle 1 has a possibility of being tailgated by the other vehicle using the expression for the determination.

### Tailgating Factor Determination Unit

In a case where it is determined that the own vehicle 1 has the possibility of being tailgated by the other vehicle, the tailgating factor determination unit 64 may execute a process for determining a factor of the own vehicle 1 that provokes tailgating. For example, the tailgating factor determination unit 64 may determine the factor that provokes tailgating by comparing the traveling state information on the own vehicle 1 with accumulated data including the traveling state information on the plurality of second vehicles of which surrounding environment belongs to the same category of the surrounding environment of the own vehicle 1 (first vehicle). The accumulated data may be stored or accumulated in the normal driving database 75. The tailgating factor determination unit 64 may store the information on the factor determined as provoking tailgating in the memory 53.

### Feedback Presentation Unit

On the basis of the factor that provokes tailgating, the feedback presentation unit 65 may execute a process for presenting feedback information on a driving action of the driver of the own vehicle 1. In this example embodiment, in a case where it is determined that the own vehicle 1 has the possibility of being tailgated, the feedback presentation unit 65 may execute a process for presenting an action for avoiding tailgating. Additionally, in this example embodiment, the feedback presentation unit 65 may execute a pre-driving process for presenting the feedback information before the start of driving and a post-driving process for presenting the feedback information after the completion of driving.

### 3. Operations of Driving Assistance Apparatus

Next, an exemplary processing operation performed by the processor 51 of the driving assistance apparatus 50 according to an example embodiment is described. Hereinafter, a vehicle traveling behind the own vehicle 1 may be referred to as a following vehicle. In one embodiment, the following vehicle may serve as a “third vehicle”.

### Tailgating Determination Process

Before a series of processing operations performed by the processor 51 is described, a tailgating determination process performed by the tailgating determination unit 63 of the driving assistance apparatus 50 according to the example embodiment is described.

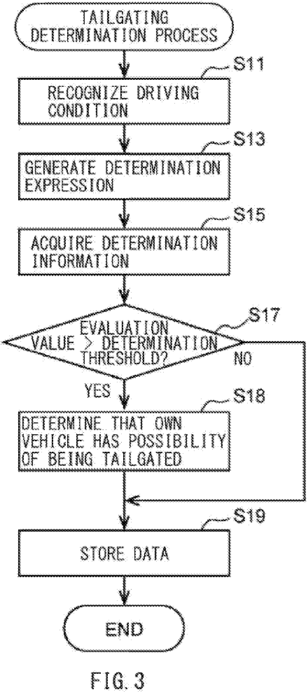

FIG. 3 is a flowchart of the tailgating determination process. The tailgating determination unit 63 may recognize the traveling environment of the own vehicle 1 (Step S11). For example, the tailgating determination unit 63 may acquire the surrounding environment information on the own vehicle 1 on the basis of detection data transmitted from the surrounding environment sensor 31 to recognize the driving condition of the own vehicle 1. The driving condition may include data on curves, slopes, traveling lanes, and the width of the road on which the own vehicle 1 is traveling, the positions of obstacles around the own vehicle 1, and the number and positions of vehicles traveling behind the own vehicle 1.

The driving condition of the own vehicle 1 may further include information on the speed limit for the road on which the own vehicle 1 is traveling and the traveling area information. The information on the speed limit and the traveling area information may be retrieved from image data transmitted from the surrounding environment sensor 31, may be acquired via road-to-vehicle communication or a beacon, or may be calculated from information on the position on a map data received from the GPS sensor 37. The driving condition of the own vehicle 1 may also include information on the present time. The driving condition of the own vehicle 1 may include information other than those described above.

Thereafter, the tailgating determination unit 63 may generate the expression for the determination as to whether the own vehicle 1 has a possibility of being tailgated (Step S13). In one example, the tailgating determination unit 63 may generate a determination expression 1 based on the driving condition.

Driving evaluation value (a × X1 + b × X2 + c × X3 + d × X4) > determination threshold (X0 - X5) ... Determination expression 1 Determination expression 1

where X0 represents a determination reference threshold, X1 represents an evaluation value of the traveling state of the own vehicle 1, X2 represents an evaluation value of the traveling state of the following vehicle, X3 represents an evaluation value of the relative position between the own vehicle 1 and the following vehicle, X4 represents an evaluation value of the feeling of the driver of the following vehicle, X5 represents an evaluation value of the tailgating characteristic of the driver of the following vehicle, and a, b, c, and d each represent a coefficient set in accordance with the driving condition.

With the determination expression 1 described above, it may be determined that the own vehicle 1 has the possibility of being tailgated in a case where the driving evaluation value, which is calculated on the basis of the traveling state of the own vehicle 1, the traveling state of the following vehicle, the relative position between the own vehicle 1 and the following vehicle, and the feeling of the driver of the following vehicle, is greater than a determination threshold. The determination threshold may be corrected in accordance with the tailgating characteristic of the driver of the following vehicle.

In one example, the evaluation value X1 of the traveling state of the own vehicle 1 may be an evaluated value (km/h) of the vehicle speed of the own vehicle 1. The evaluation value X2 of the traveling state of the following vehicle may be an evaluated value (km/h) of the vehicle speed of the following vehicle. The evaluation value X3 of the relative position between the own vehicle 1 and the following vehicle may be an evaluated value (m) of the inter-vehicle distance between the own vehicle 1 and the following vehicle. The evaluation value X4 of the feeling of the driver of the following vehicle may be an evaluated value indicating the degree of anxiety, anger, or stress of the driver of the following vehicle. For example, the evaluation value X4 may be a value obtained as a result of relative evaluation within a range from 0 to 100, where 0 may indicate that the driver is in an ordinary state, and 100 may indicate that the driver has gotten angry.

The acquisition unit 62 may analyze a facial expression of the driver of the following vehicle on the basis of the detection data transmitted from the surrounding environment sensor 31 to estimate the feeling of the driver. For example, the acquisition unit 62 may estimate the feeling of the driver using a feeling estimation program developed by a facial action coding system (FACS). Alternatively, in a case where inter-vehicle communication is available between the own vehicle 1 and the following vehicle, the acquisition unit 62 may acquire, from the following vehicle, data on the facial expression of the driver of the following vehicle and data on the results of estimation of the feeling of the driver of the following vehicle. Still alternatively, the acquisition unit 62 may acquire biological data from the following vehicle to estimate the feeling of the driver of the following vehicle on the basis of the biological data. The biological data may be data from which the feeling of the driver of the following vehicle is able to be estimated; for example, the biological data may be data on the heart rate or the pulse rate of the driver of the following vehicle. On the basis of the estimated feeling of the driver of the following vehicle, the tailgating determination unit 63 may determine the evaluation value X4 through relative evaluation within the range from 0 to 100.

The coefficients a, b, c, and d of the respective evaluation values X1, X2, X3, and X4 may each be a variable determined on the basis of the driving scene subjected to the determination as to whether the own vehicle 1 has a possibility of being tailgated. For example, the possibility of being tailgated may increase as the vehicle speed of the own vehicle 1 decreases while traveling on an expressway. Accordingly, the coefficient a of the evaluation value X1 of the vehicle speed of the own vehicle 1 may be determined such that a value “a × X1” increases as the evaluation value X1 of the vehicle speed of the own vehicle 1 decreases. In one example, the evaluation value X1 may be a reference value (zero, i.e., X1 = 0) in a case where the vehicle speed of the own vehicle 1 is 60 km/h, and the evaluation value X1 may be -20 in a case where the vehicle speed of the own vehicle 1 is 40 km/h. In this example, if the coefficient a takes a negative value, the value “a × X1” may increase as the vehicle speed of the own vehicle 1 decreases. As described above, the coefficient a may be determined on the basis of the driving scene such that the value “a × X1” increases as the own vehicle 1 travels at a vehicle speed more prone to be tailgated.

Likewise, the coefficient b may be determined on the basis of the driving scene such that a value “b × X2” increases as the own vehicle travels at a vehicle speed more prone to make the driver of the following vehicle feel anxiety, anger, or stress. The coefficient c may be determined on the basis of the driving scene such that a value “c × X3” increases as the own vehicle 1 and the following vehicle travel at an inter-vehicle distance more prone to cause the own vehicle 1 to be tailgated or make the driver of the following vehicle feel anxiety, anger, or stress with the own vehicle 1. The coefficient d may be determined on the basis of the driving scene such that a value c × X4” increases as the traveling state of the own vehicle 1 gives a larger impact on the feeling of the driver of the following vehicle. These coefficients a, b, c, and d may be determined using a learning model (a tailgating determination model) described below, for example.

The determination reference threshold X0 may be set to any value. For example, the determination reference threshold X0 may be set to 100 in a case where the vehicle speed (km/h) of the own vehicle 1, the vehicle speed (km/h) of the following vehicle, the inter-vehicle distance (m) between the own vehicle 1 and the following vehicle, and the evaluated value of the feeling of the driver of the following vehicle (0 to 100) are respectively set as the evaluation values X1, X2, X3, and X4 as described above. The evaluation value X5 of the tailgating characteristic of the driver of the following vehicle may be an evaluated value indicating the possibility that the driver of the following vehicle will tailgate the own vehicle 1. For example, the evaluation value X5 may be value obtained as a result of relative evaluation within a range from 0 to 100. The evaluation value X5 may be set to a larger value as the possibility that the driver of the following vehicle will tailgate the own vehicle 1 is higher, e.g., as the number of the past tailgating actions by the driver of the following vehicle increases. This allows the own vehicle 1 to be determined as having the possibility of being tailgated at an earlier timing.

The acquisition unit 62 may acquire the information on the tailgating characteristic of the driver of the following vehicle from the following vehicle via the inter-vehicle communication. The information on the tailgating characteristic of the driver may include, for example, data on a history of past tailgating actions and dangerous driving of the corresponding driver. The information on the tailgating characteristic of the driver may further include data on the number of times of accelerating operations, decelerating operations, steering operations, passing operations, and high beam light operations within a predetermined time.

The information on tailgating characteristic of the driver may further include information about the results of questionnaires collected from each driver and stored in the control apparatus in advance. The information on the results of questionnaires may include, for example, data on the frequency of feeling frustrated while driving, actions when feeling frustrated (honking the horn, passing, yelling, etc.), and factors that made the driver feel frustrated. On the basis of the acquired information on the tailgating characteristic, the tailgating determination unit 63 may calculate the evaluation value X5 of the tailgating characteristic through relative evaluation within the range from 0 to 100 using a predetermined expression, for example.

The acquisition unit 62 may acquire the identification information for identifying the driver of another vehicle and extract information on the tailgating characteristic of the driver from the data stored in the driver database 77. For example, the acquisition unit 62 may identify the driver of the other vehicle by extracting the facial feature amount of the driver of the other vehicle from detection data transmitted from the surrounding environment sensor 31 and referring to the driver database 77. Alternatively, the acquisition unit 62 may identify the numbers on the license plate of the other vehicle on the basis of image data transmitted from the surrounding environment sensor 31 and identify the driver of the other vehicle on the basis of the numbers identified. For example, data for correlating the license plate number with a corresponding driver may be stored in the driver database 77 or may be acquired from metadata accessible via, for example, mobile communication.

The evaluation value X1 of the traveling state of the own vehicle 1 should not be limited to the evaluated value of the vehicle speed. The evaluation value X1 of the traveling state of the own vehicle 1 may be calculated on the basis of the vehicle speed and any one or all of the amount of change in speed or the amount of change in acceleration/deceleration rate within a predetermined time, a relative speed of the following vehicle to the own vehicle 1, a speed limit of the road on which the own vehicle 1 is traveling, a difference in time between a timing of blinking an indicator and a timing of making a course change. In this case, an arithmetic expression may be determined such that the evaluation value X1 of the traveling state of the own vehicle 1 increases as the amount of change in speed or the amount of change in acceleration rate within the predetermined time takes a larger negative value, i.e., as the own vehicle 1 decelerates at a greater deceleration rate. Alternatively, the arithmetic expression may be determined such that the evaluation value X1 of the traveling state of the own vehicle 1 increases as the relative speed of the following vehicle to the own vehicle 1 is higher, as the speed limit is higher, or as the difference in time between the timing of blinking an indicator and the timing of making a course change is smaller. Note that the predetermined time may be set to any time.

The evaluation value X2 of the traveling state of the following vehicle should not be limited to the evaluated value of the vehicle speed. The evaluation value X2 of the traveling state of the following vehicle may be calculated on the basis of the vehicle speed and one or both of the amount of change in speed or the amount of change in acceleration/deceleration rate within a predetermined time. In this case, an arithmetic expression may be determined such that the evaluation value X2 of the traveling state of the following vehicle increases as the amount of change in speed or the amount of change in acceleration rate within the predetermined time takes a larger positive value, i.e., as the following vehicle accelerates at a greater acceleration rate.

The evaluation value X3 of the relative position between the own vehicle 1 and the following vehicle should not be limited to the evaluated value of the inter-vehicle distance between the own vehicle 1 and the following vehicle. The evaluation value X3 of the relative position between the own vehicle 1 and the following vehicle may be calculated on the basis of the inter-vehicle distance and any one or all of the shift amount between the traveling lane of the own vehicle 1 and the traveling lane of the following vehicle, the amount of change in inter-vehicle distance between the own vehicle 1 and the following vehicle within a predetermined time, or the amount of change in inter-vehicle distance between the own vehicle 1 and a vehicle traveling in front of the own vehicle 1 (hereinafter referred to as a preceding vehicle). In this case, an arithmetic expression may be determined such that the evaluation value X3 of the relative position increases as the shift amount between the traveling lane of the own vehicle 1 and the following vehicle is smaller. Further, the arithmetic expression may be determined such that the evaluation value X3 of the relative position increases as the amount of change in inter-vehicle distance between the own vehicle 1 and the following vehicle within the predetermined time takes a larger negative value or as the amount of change in inter-vehicle distance between the own vehicle 1 and the preceding vehicle takes a larger positive value.

The coefficients a, b, c, and d in the determination expression 1 may be set on the basis of a learning model generated by machine learning based on learning data on traveling states of the own vehicle 1 at the time of tailgating or dangerous driving of the following vehicle against the own vehicle 1, the driving action taken by the driver of the own vehicle 1, and the feeling of the driver of the following vehicle caused by the driving action. Hereinafter, the learning model may be referred to as a tailgating determination model. The tailgating determination model may be mounted on the own vehicle 1 in advance, or may be stored in a server accessible via mobile communication. Accordingly, in the determination expression 1 generated, information on a driving action prone to make the driver of the following vehicle feel anxiety, anger, or stress may be weighted on the basis of the driving conditions.

The learning data for generating the tailgating determination model may be collected from, for example, the driver of the following vehicle. In one example, the driver of the following vehicle may report a condition in which the driver felt anxiety, anger, or stress about the vehicle traveling in front, i.e., the own vehicle 1. The coefficients a, b, c, and d may be determined on the basis of the driving scene using the tailgating determination model such that the values “a × X1”, “b × X2”, “c × X3”, “d × X4” are greater in a condition in which the own vehicle 1 is more prone be tailgated or in which the driver of the following vehicle is more prone to feel anxiety, anger, or stress to the own vehicle 1. A large amount of the learning data may be necessary to generate the tailgating determination model. One example of the method of collecting the learning data is now be described.

In one example, when an unspecified driver who is driving the own vehicle feels anxiety, anger, or stress about a preceding vehicle, information on driving actions of the driver of the own vehicle (corresponding to a following vehicle in this example), information on driving actions of the driver of the preceding vehicle, information on driving conditions of the own vehicle and the preceding vehicle, and information on the feeling of the driver of the own vehicle may be stored in the control apparatus mounted in the own vehicle. These pieces of the information may be detection data acquired by, for example, the surrounding environment sensor 31, the vehicle interior camera 33, the vehicle state sensor 35 mounted in the own vehicle, and the biosensor 34, or may be data calculated from the detection data. These pieces of information may start being stored in response to a driver’s operation or may start being stored automatically when the control apparatus detects the anxiety, anger, or stress of the driver in a condition where there is a preceding vehicle.

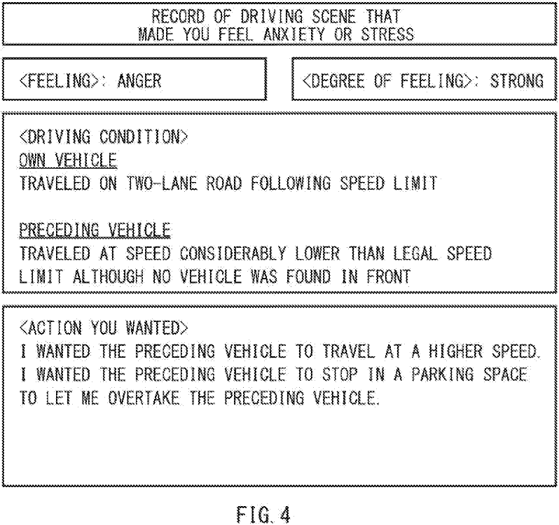

After the own vehicle is stopped, the control apparatus may display an image of predetermined questionnaire items and request the driver to answer the questionnaire. FIG. 4 illustrates an example of the display image of the results of the questionnaire. As illustrated in FIG. 4, the driver may be requested to answer the questionnaire items including “feeling”, “degree of feeling”, “driving condition”, and “action you wanted”. After receiving answers to the questionnaire, the control apparatus may send the results of the questionnaire to the server via mobile communication, for example. The data to be sent to the server may include all the stored detection data acquired by the vehicle state sensor 35 and the biosensor 34 or all the data calculated on the basis of these pieces of the detection data. Alternatively, the data to be sent to the server may include: information on the driving action of the driver of the own vehicle (corresponding to the following vehicle in this example), i.e., information regarding what kind of action the driver of the own vehicle took; information on the driving action of the driver of the preceding vehicle, i.e., information regarding what kind of action the driver of the preceding vehicle took; information on the driving conditions of the own vehicle and the preceding vehicle, i.e., information regarding what kind of condition the own vehicle or the preceding vehicle traveled in; and information on the feeling of the driver of the own vehicle, i.e., information regarding what kind of feeling the driver had.

The data on the results of the questionnaire sent to the server may be automatically or manually converted to learning data. The tailgating determination model may be generated by machine learning based on the learning data. To collect a large number of pieces of learning data, a predetermined incentive may be given to a transmission of data on the results of the questionnaire.

The method of constructing the tailgating determination model should not be limited to a particular method. For example, a known method such as a neutral network or a Bayesian network may be used as appropriate. Examples of the neutral network may include a support vector machine, a nearest neighbor algorithm, and deep learning.

After the determination expression 1 is generated on the basis of the driving condition of the own vehicle 1 in Step S13, the acquisition unit 62 may acquire determination information for determining whether the own vehicle has a possibility of being tailgated (Step S15). The determination information may include the information on the traveling state of the own vehicle 1, the information on the surrounding environment of the own vehicle 1, the information on the traveling states of the other vehicles, and the information on the relative positions between the own vehicle 1 and the other vehicles. The acquisition unit 62 may store the various kinds of data in the driving database 71 as chronological data.

In one example, the acquisition unit 62 may acquire the information on the traveling state of the own vehicle 1 in a predetermined operation cycle on the basis of detection data transmitted from the vehicle state sensor 35. The information on the traveling state of the own vehicle 1 may include data on an operating state of the own vehicle 1 and data on a behavior of the own vehicle 1. Examples of the data on an operating state of the own vehicle 1 may include data on the steering wheel or the steering angles of the steered wheels, an accelerator operation amount, a braking operation amount, and an operating state of an indicator. Examples of the data on a behavior of the own vehicle 1 may include data on a vehicle speed, a forward/backward acceleration rate, a lateral acceleration, a forward/backward jerk, and a lateral jerk.

Further, the acquisition unit 62 may acquire the information on the surrounding environment of the own vehicle 1 in a predetermined operation cycle on the basis of detection data transmitted from the surrounding environment sensor 31. Examples of the information on the surrounding environment of the own vehicle 1 may include data on the curved shape, the slope, the traveling lanes, and the width of the road on which the own vehicle 1 is traveling, and data on obstacles and other vehicles around the own vehicle. The information on the surrounding environment of the own vehicle 1 may further include data on a speed limit for the road on which the own vehicle 1 is traveling. The data on the speed limit may be retrieved from image data transmitted from the surrounding environment sensor 31, may be acquired via road-to-vehicle communication or a beacon, or may be calculated from information on a position on a map data received from the GPS sensor.

Further, the acquisition unit 62 may acquire information on the traveling state of other vehicles and information on the relative positions between the own vehicle 1 and the other vehicles in a predetermined operation cycle on the basis of detection data transmitted from the surrounding environment sensor 31. The traveling state information on the other vehicles may include at least data on behaviors of the other vehicles, such as the speeds, frontward/backward acceleration rates, and lateral acceleration rates of the other vehicles. The information on the relative positions between the own vehicle 1 and the other vehicles may include at least data on the relative speeds of the other vehicles to the own vehicle 1, the relative positions of the other vehicles to the own vehicle 1, and the distances between the own vehicle 1 and the other vehicles.

Thereafter, the tailgating determination unit 63 may substitute the acquired information on the determination expression 1 to determine whether the driving evaluation value is greater than the determination threshold (Step S17). If the driving evaluation value is not greater than the determination threshold (Step S17: NO), the tailgating determination unit 63 may determine that the own vehicle 1 has no possibility of being tailgated by the following vehicle, and the routine of the determination process may end without performing other steps. In contrast, if the driving evaluation value is greater than the determination threshold (Step S17: YES), the tailgating determination unit 63 may determine that the own vehicle 1 has the possibility of being tailgated by the following vehicle (Step S18).

Thereafter, the tailgating determination unit 63 may set a tailgated driving flag in the various kinds of data acquired in a predetermined time before and after the time when the own vehicle is determined as having the possibility of being tailgated by the following vehicle, stores the data in the driving database 71 (Step S19), and end the routine of the determination process.

As described above, the tailgating determination unit 63 in the driving assistance apparatus 50 according to the example embodiment may acquire the information on the traveling state of the own vehicle 1, the information on the traveling state of the following vehicle, the information on the relative positions between the own vehicle 1 and the following vehicles, and the information on the tailgating characteristics of the drivers. On the basis of the acquired information, the tailgating determination unit 63 may determine whether the own vehicle has the possibility of being tailgated by the following vehicle using the determination expression 1 described above. For example, if the driver of the following vehicle has a history of past tailgating actions, the determination threshold may be smaller. Accordingly, as the driver of the following vehicle is more prone to tailgate a vehicle, the determination threshold may take a lower value, and the own vehicle 1 is more likely to be determined as having the possibility of being tailgated by the following vehicle.

According to the example embodiment described above, the evaluation value X4 of the feeling of the driver of the following vehicle may be reflected on the determination. That is, the determination as to whether the own vehicle 1 has a possibility of being tailgated is made on the basis of the tailgating characteristic of the driver of the following vehicle and an emotional state of the driver of the following vehicle. For example, in a case where the driver of the following vehicle feels anger, the driving evaluation value may take a large value. Accordingly, the driving evaluation value may increase as the degree of anger of the driver of the following vehicle increases, and the own vehicle 1 is thus more likely to be determined as having the possibility of being tailgated by the following vehicle.

Therefore, according to the tailgating determination method of the example embodiment, it is possible to appropriately determine whether the own vehicle 1 has a possibility of being tailgated by the following vehicle.

### Operations of Driving Assistance Process

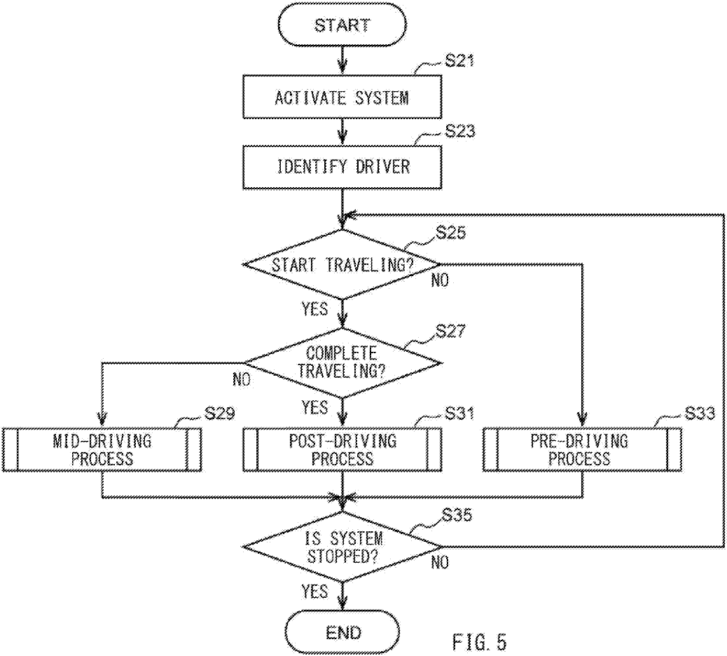

In the following, a series of processing operations performed by the driving assistance apparatus 50 according to the example embodiment is described. FIG. 5 is a flowchart of a main routine of processing operations performed by the processor 51.

After an in-vehicle system including the driving assistance apparatus 50 is activated (Step S21), the driver determination unit 61 of the processor 51 may execute a process for identifying the driver of the own vehicle 1 (Step S23). In one example, the driver determination unit 61 may execute a process for identifying the face of the driver seated on the driver’ seat on the basis of image data transmitted from the vehicle interior camera 33. Further, the driver determination unit 61 may execute a process for extracting the feature amount of the face of the driver identified, and determine whether information on a driver whose feature amount is identical to the extracted feature amount is stored in the driver database 77. If there is no information on a driver whose feature amount is identical to the extracted feature amount in the driver database 77, the driver determination unit 61 may assign identification data to each driver identified, store the identification data together with the data on the feature amount in the driver database 77, and store the identification information on the memory 53. In contrast, if there is the information on a driver whose feature amount is identical to the extracted feature amount in the driver database 77, the driver determination unit 61 may store the detected identification data for identifying the driver in the memory 53.

Thereafter, the feedback presentation unit 65 of the processor 51 may determine whether the own vehicle 1 has started traveling (Step S25). In one example, the feedback presentation unit 65 may determine that the own vehicle 1 has started traveling in a case where the position of the shift lever is switched to the drive range D or where a target driving torque of the own vehicle 1 is set to a positive value greater than zero after the activation of the in-vehicle system. However, the method of determining whether the own vehicle 1 has started driving should not be limited the example described above.

To facilitate understanding, the case where it is determined that the own vehicle 1 has started traveling is described first, following which the case where it is not determined that the own vehicle 1 has started traveling is described.

If it is determined that the own vehicle 1 has started traveling (Step S25: YES), the feedback presentation unit 65 may determine whether the own vehicle 1 has completed traveling (Step S27). In one example, the feedback presentation unit 65 may determine that the own vehicle has completed traveling in a case where the position of the shift lever is switched to the parking range P, in a case where a switch of the in-vehicle system is turned off, or in a case where the own vehicle 1 has reached a set destination. However, the method of determining whether the own vehicle 1 has completed traveling should not be limited to the example described above.

If it is not determined that the own vehicle 1 has completed traveling (Step S27: NO), the processor 51 may execute a mid-driving process (Step S29).

### Mid-driving Process

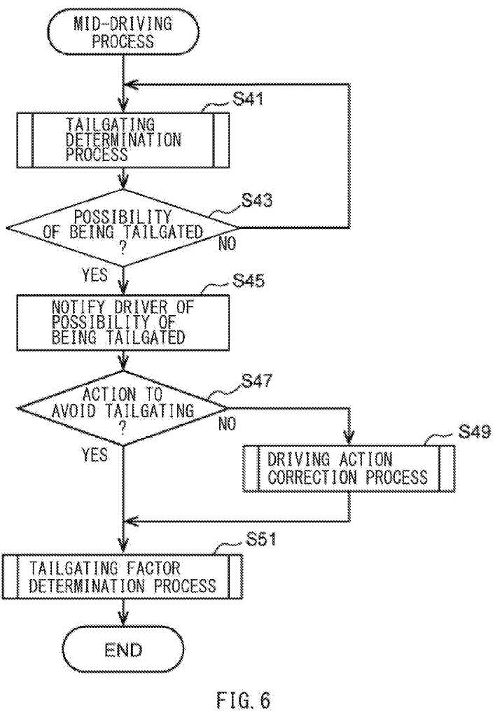

FIG. 6 illustrates a flowchart of the mid-driving process. In the mid-driving process, the tailgating determination unit 63 may execute the tailgating determination process in accordance with a procedure of the flowchart illustrated in FIG. 3 (Step S41). The tailgating determination unit 63 may determine whether the own vehicle 1 has a possibility of being tailgated by the following vehicle on the basis of the information on the traveling state of the own vehicle 1, the information on the traveling state of the following vehicle, the information on the relative position between the own vehicle 1 and the following vehicle, and the information on the tailgating characteristic of the driver of the following vehicle.

After the tailgating determination process is executed in Step S41, the feedback presentation unit 65 may determine whether the own vehicle 1 has a possibility of being tailgated by the following vehicle (Step S43). If the feedback presentation unit 65 determines that the own vehicle has no possibility of being tailgated by the following vehicle (S43: NO), the process may return to Step S41 in which the tailgating determination process is repeated.

In contrast, if the feedback presentation unit 65 determines that the own vehicle 1 has the possibility of being tailgated by the following vehicle (Step S43: YES), the feedback presentation unit 65 may execute a process for notifying the driver of the own vehicle 1 of the possibility of being tailgated by the following vehicle (Step S45). In one example, the feedback presentation unit 65 may notify the driver of the own vehicle 1 of the possibility of being tailgated by the following vehicle by causing the HMI 43 to generate a sound, a voice, or an image for the notification. In the notification, not only the possibility of being tailgated by the following vehicle but also the position or the current driving condition of the following vehicle may be notified.

Thereafter, the tailgating determination unit 63 may determine whether the driver of the own vehicle 1 has taken a driving action to avoid the tailgating (Step S47). For example, the tailgating determination unit 63 may determine that the driver of the own vehicle 1 has taken a driving action to avoid the tailgating in a case where the evaluation value X4 calculated on the basis of the feeling of the driver of the following vehicle acquired by the acquisition unit 62 is less than a predetermined threshold. In contrast, the tailgating determination unit 63 may determine that the driver of the own vehicle 1 has taken no driving action to avoid the tailgating in a case where the driver of the own vehicle takes no action to avoid the tailgating within a predetermined time.

In a case where the tailgating determination unit 63 determines that the driver of the own vehicle 1 has taken a driving action to avoid the tailgating (Step S47: YES), the process may proceed to Step S51 without executing other steps. In contrast, in a case where the tailgating determination unit 63 determines that the driver of the own vehicle 1 has taken no driving action to avoid the tailgating (Step S47: NO), the feedback presentation unit 65 may urge the driver of the own vehicle 1 to correct a current driving action (Step S49).

### Driving Action Correction Process

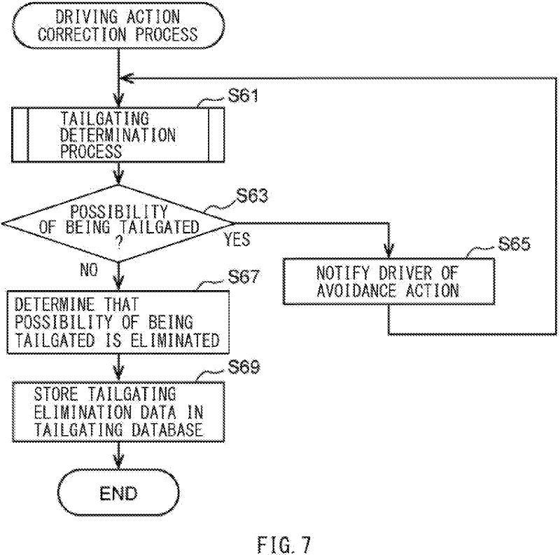

FIG. 7 illustrates a flowchart of a driving action correction process. The tailgating determination unit 63 may execute the tailgating determination process in accordance with the procedure of the flow chart illustrated in FIG. 3 (Step S61). The tailgating determination unit 63 may determine whether the own vehicle 1 has a possibility of being tailgated by the following vehicle on the basis of the information on the traveling state of the own vehicle 1, the information on the traveling state of the following vehicle, the information on the relative position between the own vehicle 1 and the following vehicle, and the information on the tailgating characteristic of the driver of the following vehicle.

Thereafter, the feedback presentation unit 65 may determine whether the own vehicle 1 has been determined as having a possibility of being tailgated by the following vehicle as a result of the tailgating determination process (Step S63). If it is determined that the own vehicle 1 still has a possibility of being tailgated (Step S63: YES), the feedback presentation unit 65 may notify the driver of the own vehicle 1 of the driving action to avoid the tailgating (hereinafter referred to as an avoidance action) (Step S65). In one example, the feedback presentation unit 65 may determine the avoidance action on the basis of the information on the traveling state of the own vehicle 1, the information on the traveling state of the following vehicle, and the information on the surrounding environment of the own vehicle 1, and may cause the HMI 43 to notify the driver of the own vehicle 1 of the avoidance action.

For example, the feedback presentation unit 65 may notify the driver of the own vehicle 1 to accelerate the own vehicle 1 in a case where the own vehicle 1 is traveling at a speed considerably lower than a legal speed limit. In a case where no vehicle is traveling on a lane adjacent to the lane of the own vehicle 1 while the own vehicle 1 is traveling on a road with two or more lanes, the feedback presentation unit 65 may notify the driver of the own vehicle 1 to make a lane change. In a case where a road shoulder is sufficiently large, the feedback presentation unit 65 may notify the driver of the own vehicle 1 to move toward the road shoulder. However, the content of the notification of the avoidance action should not be limited to the examples described above; the content of the notification of the avoidance action may be appropriately determined on the basis of the driving condition of the own vehicle 1. After the feedback presentation unit 65 notifies the driver of the own vehicle 1 of the avoidance action, the process may return to Step S61 in which the tailgating determination unit 63 repeats the tailgating determination process.

If it is determined that the own vehicle 1 has no possibility of being tailgated by the following vehicle as the result of the tailgating determination process (Step S63: NO), the tailgating determination unit 63 may determine that the condition in which the own vehicle 1 has the possibility of being tailgated by the following vehicle has been eliminated (Step S67). Thereafter, the tailgating determination unit 63 may store tailgating elimination data, i.e., data on the avoidance action acquired at the time when the condition in which the own vehicle 1 is determined as having the possibility of being tailgated by the following vehicle is eliminated, in the tailgating case database 73 in association with the information on the traveling state of the own vehicle 1, the information on the traveling state of the following vehicle, and the information on the relative position between the own vehicle 1 and the following vehicle acquired at the time when the own vehicle is determined as having the possibility of being tailgated by the following vehicle (Step S69). Thereafter, the driving action correction process may end.

Description is made with reference to FIG. 6 again. If it is determined that the driver of the own vehicle 1 has taken a driving action to avoid the tailgating (Step S47: YES) or if the driving action correction process in Step S49 is completed, the tailgating factor determination unit 64 of the processor 51 may execute a process for determining the factor of the own vehicle 1 that provokes tailgating (Step S51). In a first example according to the example embodiment, the tailgating factor determination unit 64 may determine the factor that provokes the tailgating by comparing the data on the traveling state of the own vehicle 1 acquired at the time when the own vehicle 1 is determined as having the possibility of being tailgated by the following vehicle with the data on a normal driving condition in which the own vehicle 1 is not tailgated by the following vehicle. In a second example according to the example embodiment, the tailgating factor determination unit 64 may determine the factor that provokes the tailgating by comparing the data on the driving action performed by the driver of the own vehicle 1 at the time when the own vehicle 1 is determined as having the possibility of being tailgated by the following vehicle with the data on the driving action acquired at the time when the avoidance action is appropriately taken by the driver. However, the tailgating factor determination unit 64 may be configured to execute either one of the first example and the second example.

### Tailgating Factor Determination Process

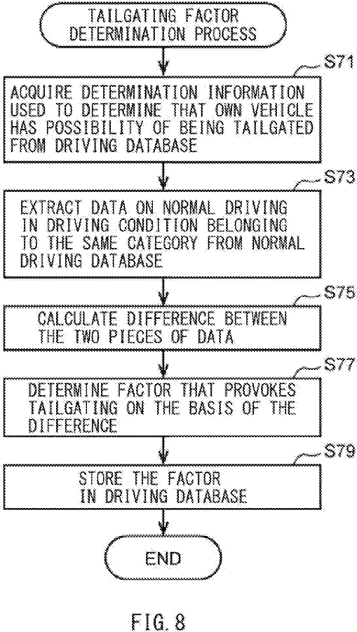

FIG. 8 illustrates a flowchart of the first example of the tailgating factor determination process. First, the tailgating factor determination unit 64 may refer to the driving database 71 to acquire the determination information used by the tailgating determination unit 63 to determine that the own vehicle 1 has the possibility of being tailgated by the following vehicle (Step S71). Thereafter, the tailgating factor determination unit 64 may refer to the normal driving database 75 to extract data on normal driving in a driving condition that belongs to the same category as the driving condition in which the own vehicle 1 is determined as having the possibility of being tailgated by the following vehicle (Step S73). The data on driving conditions belonging to the same category may be identical to each other in, for example, a predetermined number of pieces of data on the curved shape, inclination, traveling lane, and width of the road on which the own vehicle 1 is traveling, the positions of obstacles present around the own vehicle 1, the number of the following vehicles, and the positions of the following vehicles. Alternatively, the data on driving conditions belonging to the same category may be data on the vehicles having traveled in the same section. It is possible to provide more accurate results by comparing with the data on the own vehicle 1 with the data about the same section.

It may be determined that pieces of data on the driving conditions belong to the same category in a case where they are identical in the traveling area or the traveling time. The extracted data may be comparative data to be compared with the determination information. The extracted data may be any number of pieces of data selected from the information on the traveling state of the own vehicle 1. For example, the extracted data may include the amount of change in acceleration or deceleration rate, the amount of change in speed, and the amount of change in inter-vehicle distance per a predetermined time.

Thereafter, the tailgating factor determination unit 64 may compare the determination information with the data extracted from the normal driving database to calculate the difference between the two pieces of data (Step S75). In one example, the difference may be calculated as the ratio of the difference between the normal driving data and the target data of the determination information to the value of the target data extracted from the normal driving database (hereinafter referred to as normal driving data). Thereafter, the tailgating factor determination unit 64 may determine the factor that provokes tailgating on the basis of the difference (Step S77). Thereafter, the tailgating factor determination unit 64 may store the information on the results of comparison between the data of the determination information and the normal driving data extracted from the normal driving database in the driving database 71 (Step S79). Thereafter, the tailgating factor determination process may end.

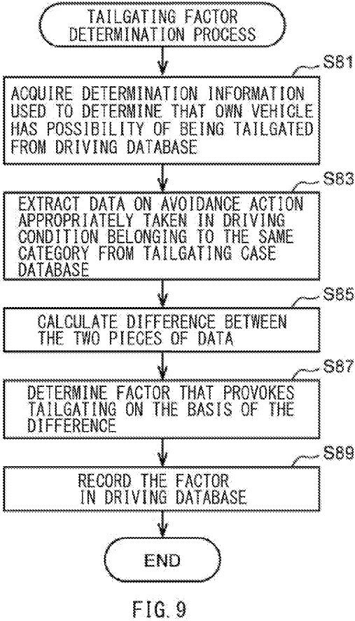

FIG. 9 illustrates a flowchart of the second example of the tailgating factor determination process. First, as in Step S71 described above, the tailgating factor determination unit 64 may refer to the driving database 71 to acquire the determination information used by the tailgating determination unit 63 to determine that the own vehicle 1 has the possibility of being tailgated by the following vehicle (Step S81). The determination information may include information with which the driving action of the driver of the own vehicle 1 is identifiable. The determination information may further include information on the line of sight of the driver detected and stored by the vehicle interior camera 33.

Thereafter, the tailgating factor determination unit 64 may refer to the tailgating case database 73 to extract data on an avoidance action appropriately taken in a tailgating driving case in the driving condition belonging to the same category as the driving condition in which the own vehicle 1 is determined as having the possibility of being tailgated by the following vehicle (Step S83). The data on the avoidance action appropriately taken may be data on a driving action performed by the driver to immediately eliminate the condition in which the vehicle has the possibility of being tailgated by the following vehicle, and may include the data stored in Step S69 described above.

Thereafter, the tailgating factor determination unit 64 may compare the determination information with the data on the avoidance action extracted from the tailgating case database to calculate the difference between the two pieces of data (Step S85). Thereafter, the tailgating factor determination unit 64 may determine the factor that provokes tailgating on the basis of the difference (Step S87). Thereafter, the tailgating factor determination unit 64 may store the information on the results of comparison between the driving action data of the determination information and the avoidance action data extracted from the tailgating case database in the driving database 71 (Step S89). Thereafter, the tailgating factor determination process may end.

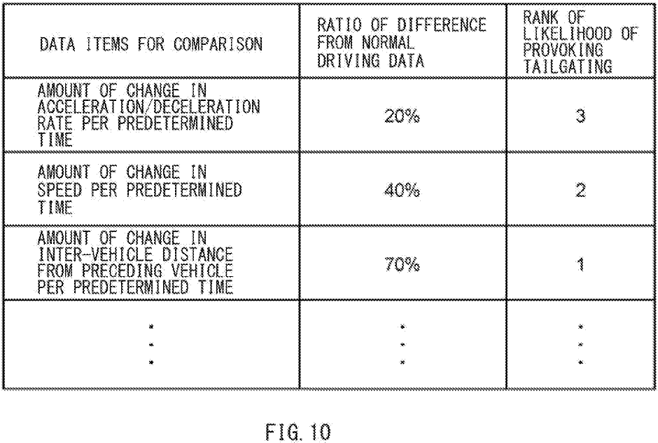

FIG. 10 illustrates an example of the result of comparison between the data of the determination information and the data extracted from the normal driving database. In the example illustrated in FIG. 10, the results of comparison between the data of the determination information and the data extracted from the normal driving database in a driving condition in which the driver of the following vehicle felt irritated with the own vehicle 1 traveling at a speed considerably lower than a speed limit. In this example, the ratio of difference in the amount of change in acceleration/deceleration rate per a predetermined time from the normal driving data may be 20%, the ratio of difference in the amount of change in speed per a predetermined time from the normal driving data may be 40%, and the ratio of difference in the amount of change in inter-vehicle distance between the own vehicle 1 and the preceding vehicle per a predetermined time from the normal driving data may be 70%. In this case, the amount of change in inter-vehicle distance between the own vehicle 1 and the preceding vehicle per a predetermined time, the amount of change in speed per a predetermined time, and the amount of change in acceleration or deceleration rate per a predetermined time may be more prone to provoke tailgating in descending order. Note that the comparison data items illustrated in FIG. 10 are mere examples, and other data items may be compared with each other.

Description is made with reference to FIG. 5 again. The processor 51 may repeatedly execute the mid-driving process described above unless it is determined that the in-vehicle system is stopped in Step S35 while the own vehicle 1 is traveling or unless it is determined that the own vehicle 1 is stopped traveling in Step S27. Accordingly, it is possible to determine that the own vehicle has the possibility of being tailgated by the following vehicle at an appropriate timing while the own vehicle 1 is traveling in view of the tailgating characteristic of the driver of the following vehicle. If it is determined that the own vehicle 1 has the possibility of being tailgated by the following vehicle, the factor that provokes the tailgating is determined and stored.

In contrast, if it is determined that the own vehicle 1 is stopped traveling (Step S27: YES), the feedback presentation unit 65 may execute a post-driving process (Step S31).

### Post-Driving Process

FIG. 11 is a flowchart of the post-driving process. First, the feedback presentation unit 65 may refer to the driving database 71 (Step S91). As described above, the driving database 71 may store the traveling data in association with the respective drivers. The feedback presentation unit 65 may calculate the type of the driver of the own vehicle 1 (hereinafter referred to as a driver type) on the basis of the driving action data on the driver of the own vehicle 1 (Step S93). The driver type may be driving characteristic information regarding a category of the driving action that the driver of the own vehicle 1 is not good at. For example, the driving characteristics may be classified into several categories: “not good at lane changing”, “not good at keeping a speed”, and “not good at recognizing an appropriate inter-vehicle distance”. The feedback presentation unit 65 may compare the driving action data on the driver of the own vehicle 1 with the traveling data on a driving action that does not provoke tailgating stored in the normal driving database 75, to thereby estimate the driving action that the driver of the own vehicle 1 is not good at. The feedback presentation unit 65 may store the calculated driver type in the memory 53.

Thereafter, the feedback presentation unit 65 may determine whether the driving database 71 includes any record of the determination as having the possibility of being tailgated by the following vehicle performed in a period from the start to the end of the current driving (Step S95). If no record on the determination as having the possibility of being tailgated is stored (Step S95: NO), the feedback presentation unit 65 may present feedback information indicating that there was no condition in which the own vehicle 1 had the possibility of being tailgated (Step S99). For example, the feedback presentation unit 65 may generate feedback image data as appropriate and cause the HMI 43 to display the feedback image. The method of presenting the feedback information should not be limited to displaying the feedback image. The feedback information may be presented by outputting a voice or sound or by the combination of outputting a voice or sound and displaying an image.

In contrast, if the record on the determination as having the possibility of being tailgated is stored (Step S95: YES), the feedback presentation unit 65 may execute a process for generating a driving improvement comment on the basis of the data stored in the driving database 71 (Step S97). The driving improvement comment may be a comment to make the driver of the own vehicle 1 recognize his/her own driving action prone to provoke tailgating and encourage improvement in driving. The feedback presentation unit 65 may automatically generate the driving improvement comment using the factor determined by the tailgating factor determination unit 64, the vehicle behavior data indicating the condition where the own vehicle 1 was tailgated by the following vehicle, the driving action data, and the surrounding environment data. For example, the feedback presentation unit 65 may automatically generate the driving improvement comment by extracting an appropriate comment for the driving condition in which the own vehicle 1 was tailgated by the following vehicle from text data prepared in advance. The driving improvement comment generated by the feedback presentation unit 65 may be advice sentences such as “You had a *** driving action in the condition in which ***, which might provoke a following vehicle to ***. You are asked to be more careful in the future driving”.

Note that the method of generating the driving improvement comment and the content of the driving improvement comment should not be limited to the examples described above. The driving improvement comment may be generated by any known method and may have any known content.

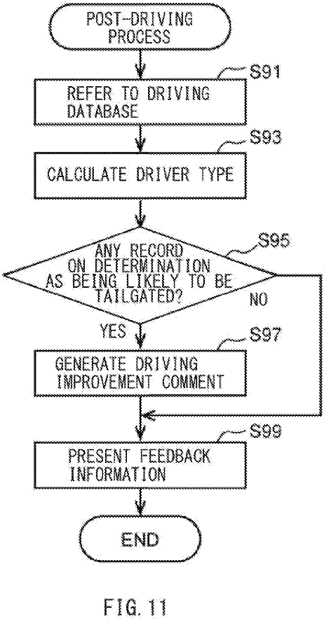

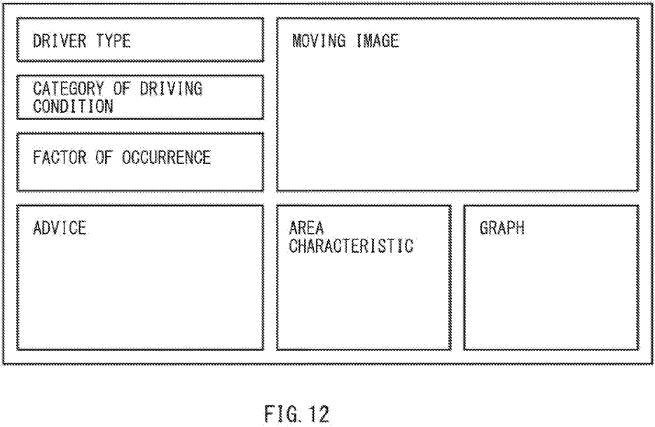

Thereafter, the feedback presentation unit 65 may present feedback information based on the generated driving improvement comment (Step S99). FIG. 12 illustrates a layout example of a feedback screen that notifies the driver of the own vehicle 1 of advice on avoiding tailgating. In the example illustrated in FIG. 12, the feedback screen may include the information on the driver type of the driver of the own vehicle 1, the category of the driving condition in which the own vehicle 1 had the possibility of being tailgated by the following vehicle, the factor that provokes the tailgating (the factor of occurrence of tailgating), and advice (improvement).

The driver type may correspond to the information calculated and stored in Step S93, i.e., the information regarding the driving characteristic indicating the category of the driving action that the driver of the own vehicle 1 is not good at. The information on the category of the driving condition in which the own vehicle 1 had the possibility of being tailgated by the following vehicle may correspond to the information determined in Step S73 described above, i.e., the information classified according to the information on the behavior of the own vehicle 1, the driving action of the driver of the own vehicle 1, and the surrounding environment of the own vehicle 1. The factor that provoked the tailgating may correspond to the information determined and stored in Step S51. The information on advice may correspond to the information on the driving improvement comment generated in Step S97 described above. The presented feedback information including these pieces of information allows the driver of the own vehicle 1 to recognize the driving action that the driver is not good at, the actual condition in which the own vehicle 1 had the possibility of being tailgated by the following vehicle, and the factor that provokes the tailgating, and easily understand which driving action is to be taken in such a condition.

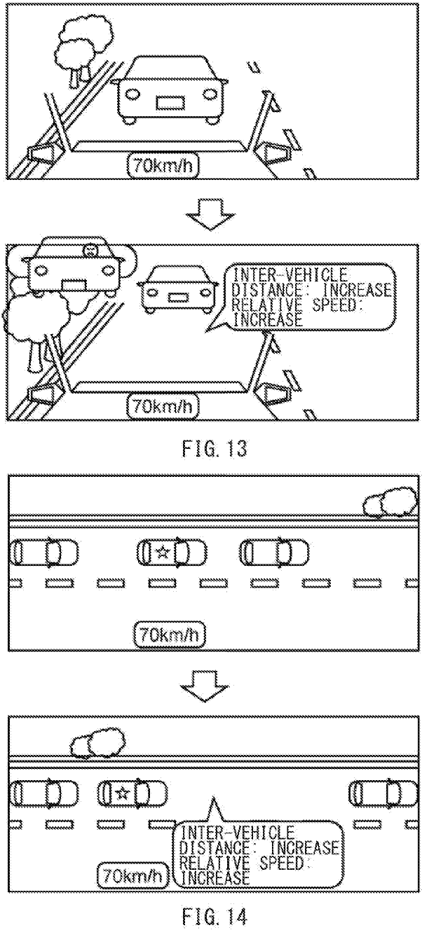

In the example illustrated in FIG. 12, a moving image of the driving scene determined as the condition in which the own vehicle 1 had the possibility of being tailgated by the following vehicle is replayed. FIGS. 13 to 15 illustrate respective example moving image patterns to be replayed. The driving scenes illustrated in FIGS. 13 to 15 may correspond to the respective examples of the comparison results illustrated in FIG. 10. In these moving image patterns of the driving scenes replayed, the driver of the following vehicle felt irritated with the own vehicle 1 traveling at a speed considerably lower than a speed limit.

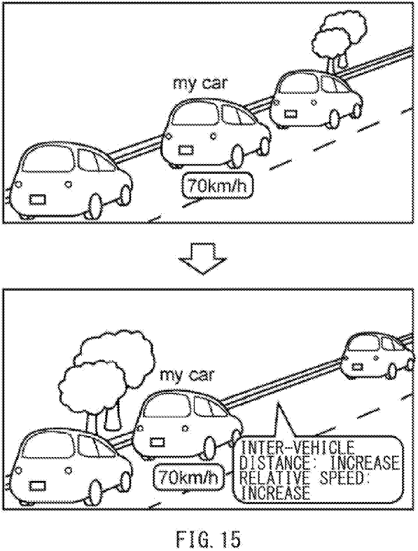

FIG. 13 illustrates an example pattern of the moving image of the driving scene viewed by the driver. FIG. 14 illustrates an example pattern of the moving image of the driving scene in a bird’s eye view. FIG. 15 illustrates an example pattern of the moving image of the driving scene in a 3D display. While each of the moving image patterns is replayed, an explanation on the vehicle speed of the own vehicle 1 and an increase in the inter-vehicle distance between the own vehicle 1 and the preceding vehicle may be displayed. This allows the driver to easily recognize that the own vehicle 1 had the possibility of being tailgated by the following vehicle, giving the driver a convincing explanation that the advice presented is appropriate.

The feedback presentation unit 65 may generate these moving image patterns in the form of animation using image data received from the front imaging cameras 31LF and 31RF, the rear imaging camera 31R, and non-illustrated cameras placed on left and right sideview mirrors, for example. One moving image pattern to be displayed may be selected from the moving image patterns on the basis of the driving scene or the factor that provokes tailgating, to facilitate understanding of the driving scene or the factor that provokes tailgating.

The feedback screen exemplified in FIG. 12 may further include information on an “area characteristic” about a driving tendency in an area in which the own vehicle 1 has traveled, and information on a “graph” of the area characteristic. Details of the information on the area characteristic and the information on the graph that are displayed on the feedback screen are described below.

As described above, the feedback presentation unit 65 may execute the post-driving process after the completion of the driving of the own vehicle. Description is made with reference to FIG. 5 again. After the post-driving process is completed, the feedback presentation unit 65 may determine whether the in-vehicle system is stopped (Step S35). If the in-vehicle system is not stopped (Step S35: YES), the processor 51 may end the processing operation. In contrast, if the in-vehicle system is not stopped (Step S35: NO), the process may return to Step S25.

If it is not determined that the own vehicle 1 starts driving in Step S25 (Step S25: NO), the feedback presentation unit 65 may execute a pre-driving process (Step S33).

### Pre-Driving Process

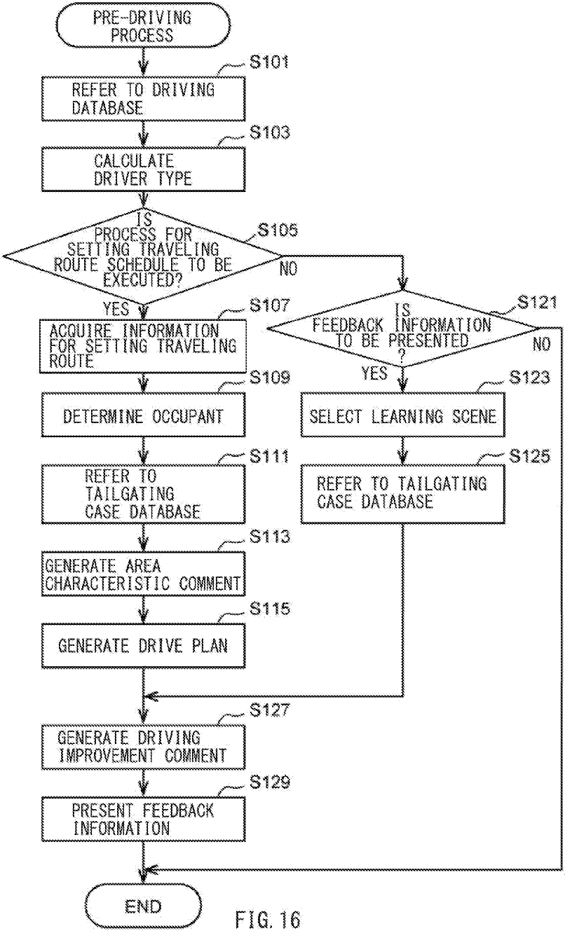

FIG. 16 is a flowchart of the pre-driving process. First, the feedback presentation unit 65 may refer to the driving database 71 (Step S101), and, as in Step S93 described above, may calculate the driver type of the driver of the own vehicle 1 on the basis of the driving action data of the driver of the own vehicle 1 (Step S103).

Thereafter, the feedback presentation unit 65 may determine whether a process for setting a traveling route schedule is to be executed (Step S105). For example, the feedback presentation unit 65 may acquire information for setting a destination from the navigation system 40, and may determine that the process for setting the traveling route schedule is to be executed if the destination is set. Alternatively, the feedback presentation unit 65 may determine that the process for setting the traveling route schedule is to be executed when the driver or occupant of the own vehicle 1 inputs a command to execute the process for setting the traveling route schedule.

If it is determined that the process for setting the traveling route schedule is to be executed (Step S105: YES), the feedback presentation unit 65 may acquire the information for setting the traveling route from the navigation system 40 (Step S107). The information for setting the traveling route may include data on a departure point, a current location, waypoints, a destination, or a departure time, for example.

Thereafter, the feedback presentation unit 65 may determine an occupant recognizable as the driver of the own vehicle 1 (Step S 109). In one example, the feedback presentation unit 65 may recognize occupants in the own vehicle 1 on the basis of image data transmitted from the vehicle interior camera 33, and may determine occupants recognizable as the drivers. For example, the feedback presentation unit 65 may determine all occupants whose past traveling data are stored as the occupants recognizable as the driver. The feedback presentation unit 65 may display the recognized occupants on the HMI 43, and the occupants in the own vehicle 1 may select one or more of the recognized occupants. The feedback presentation unit 65 may determine the selected occupant(s) as the occupant(s) recognizable as the driver. Note that the method of determining the occupant(s) recognizable as the driver should not be limited to the example described above.

Thereafter, the feedback presentation unit 65 may refer to the tailgating case database 73 to extract data on a tailgating event related to the traveling route (Step S 111). In one example, the feedback presentation unit 65 may extract data on the driving scene of the most common past tailgating event from the data about past tailgating events occurred in the traveling route connecting the departure point to the destination via a waypoint. The data about the past tailgating events may be included in the traveling route information acquired in Step S107. In this case, a plurality pieces of data on past tailgating events occurred in traveling time overlapping each other may be extracted in consideration of the present time and scheduled time of arrival at the destination.

Thereafter, the feedback presentation unit 65 may generate an area characteristic comment on the basis of the extracted data on the tailgating event (Step S1 13). The area characteristic comment may be information generated to notify the driver of the own vehicle 1 of driving characteristics of the traveling area including the traveling route of the own vehicle 1, such as traffic manners or driving practices. For example, the driving characteristics of drivers may differ depending on regional factors, such as cultural or racial backgrounds. The area characteristic may indicate, for example, that a large number of sudden lane changes has been made, an average cruising speed is low, or an inter-vehicle distance is large. When the driver drives the own vehicle 1 in a usual manner in an area in which the driver drives the own vehicle 1 for the first time, the own vehicle 1 is likely to be tailgated by another vehicle. Thus, the feedback presentation unit 65 may generate the area characteristic comment on the basis of the extracted data on the tailgating event.

The area characteristic comment may be generated following the method of generating the driving improvement comment described above. For example, the area characteristic comment may be automatically generated by mapping the data on the tailgating event including the information on the factor that provokes tailgating to the text data on the outputted comments stored in the memory 53 in advance. The text data may include data regarding which driving action is to be taken (or should have been taken) at which timing and in which driving scene. In the present example embodiment, the feedback presentation unit 65 may generate a graph indicating data in association with the driving characteristic of the traveling area, as well as the area characteristic comment.

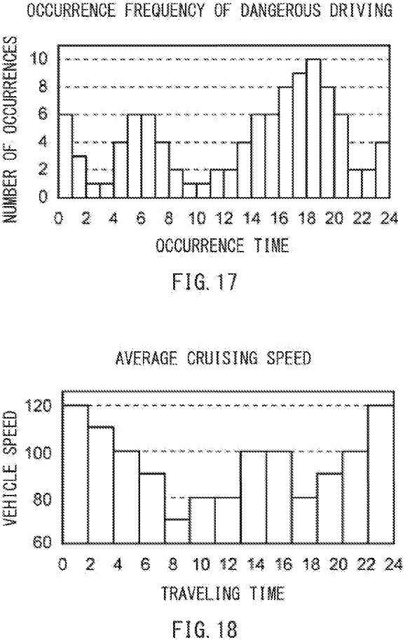

FIGS. 17 and 18 are graphs each illustrating data relevant to the driving characteristic of a traveling area. FIG. 17 illustrates data on the frequency of occurrence of dangerous driving in the traveling area. Each bar of the graph in FIG. 17 represents the number of occurrences of dangerous driving in each occurrence time. FIG. 18 illustrates data on the average cruising speed in the traveling area. Each bar of the graph in FIG. 18 represents an average cruising speed in each traveling time. Note that the data relevant to the driving characteristic of the traveling area should not be limited to the examples described above.

The feedback presentation unit 65 may generate and output a drive plan to the destination (Step S1 15). For example, the possibility that the own vehicle 1 will be tailgated by the following vehicle may differ depending on the driving characteristic of the driver, the road shape of the traveling route, and the area characteristic. Thus, the feedback presentation unit 65 may analyze the driver type of each occupant recognizable as the driver and generate the drive plan on the basis of the road shape of the traveling route from the current location to the destination and the area characteristic so as to to minimize the possibility of being tailgated by the following vehicle. In one example, to minimize the possibility of being tailgated by the following vehicle, the feedback presentation unit 65 may generate a plan about a change in driver and a plan about rest points to change the driver.

In one example, the feedback presentation unit 65 may output the drive plan to the navigation system 40, and the rest points (stop-off points) on the way of the traveling route to the destination may be set in the navigation system 40. However, the generated drive plan may not be reflected on the setting of the navigation system 40. The generated drive plan may be displayed on the HMI 43, a smartphone, or another device.

Thereafter, the feedback presentation unit 65 may execute a process for generating the driving improvement comment (Step S127). The driving improvement comment generated in this process may be a comment to be presented together with the area characteristic comment as the feedback information. For example, the driving improvement comment may be advice for at least one driver set as the driver in the drive plan, regarding what action is to be taken at which timing during driving that the driver is not good at. The process for generating the driving improvement comment may be the same as the process for generating the driving improvement comment in Step S97 described above except that the driving improvement comment generated is presented together with the area characteristic comment.

Thereafter, the feedback presentation unit 65 may present the feedback information based on the area characteristic comment and the driving improvement comment generated (Step S129). For example, the feedback presentation unit 65 may display the feedback information on the feedback screen illustrated in FIG. 12. In this case, the information on advice (improvement) generated in Step S127 may include the driving improvement comment. The information on the area characteristics may include the comment on the area characteristic generated in Step S113. The information on the area characteristic may further include map information indicating a corresponding area in addition to the comment on the area characteristic.

In the information on the graph, the graphs illustrated in FIGS. 17 and 18 may be displayed. Displaying the data on the occurrence frequency illustrated in FIG. 17 raises driver’s awareness of safe driving in the time when tailgating occurs frequently, and urges the driver to set a drive plan that allows the driver to travel in an area where tailgating is unlike to occur. Further, displaying the data on the average cruising speed illustrated in FIG. 18 allows the driver to know an adequate vehicle speed in a traveling area and perform driving following a traffic flow. Displaying the data on the average cruising speed illustrated in FIG. 18 also urges the driver who is not good at driving at a high vehicle speed to set a drive plan to avoid time when the average cruising speed is high. Additionally, displaying the graph about a variety of types of data helps prevent the driver from performing driving that provokes tailgating.

In contrast, if it is not determined in Step S105 that the process for setting the traveling route schedule is to be executed (Step S105: NO), the feedback presentation unit 65 may determine whether the feedback information is to be presented to the driver of the own vehicle 1 before the start of driving (Step S121). For example, the feedback presentation unit 65 may determine that the feedback information is to be presented in a case where the driver performs an input operation to request presentation of the feedback information. In a case where the feedback information is preset to be presented when the traveling route schedule is not set, the determination process in Step S121 may be omitted.

If it is not determined that the feedback information is to be presented (Step S121: NO), the feedback presentation unit 65 may end the pre-driving process. In contrast, if it is determined that the feedback information is to be presented (Step S121: YES), the feedback presentation unit 65 may select a learning scene to be used for the presentation of the feedback information (Step S123). For example, the feedback presentation unit 65 may select a learning scene about which advice on driving that the driver is not good at is to be presented in accordance with the items of the driver type, such as “not good at lane changing”, “not good at keeping a speed”, or “not good at recognizing an appropriate inter-vehicle distance”. Alternatively, the feedback presentation unit 65 may display options of the learning scenes to allow the driver to select some of the learning scenes. Still alternatively, the learning scenes may be selected at random.

Thereafter, the feedback presentation unit 65 may refer to the tailgating case database 73 to extract data on a tailgating event corresponding to the selected learning scene (Step S125). For example, the feedback presentation unit 65 may extract data on a tailgating event whose traveling time and traveling area respectively overlap with the present time and the current location.

Thereafter, the feedback presentation unit 65 may execute the process for generating the driving improvement comment (Step S127). The driving improvement comment generated in Step S127 may be advice for the driver who wants to improve his/her driving action about what action is to be taken at which timing. The process for generating the driving improvement comment may be the same as the process for generating the driving improvement comment in Step S97 described above.

Thereafter, the feedback presentation unit 65 may present the feedback information based on the driving improvement comment generated (Step S129). For example, the feedback presentation unit 65 may display the feedback information on the feedback screen illustrated in FIG. 12. In this case, the information on advice (improvement) generated in Step S127 may include the driving improvement comment. The information on the area characteristic and the information on graph may include the information about any traveling area selected, such as a current position of the own vehicle 1 or a traveling area in which the driver of the own vehicle 1 often travels.

As described above, the feedback presentation unit 65 may execute the pre-driving process before the own vehicle 1 starts driving. Description is made with reference to FIG. 5 again. The feedback presentation unit 65 may determine whether the in-vehicle system is stopped after the completion of the pre-driving process (Step S35). If the in-vehicle system is stopped (Step S35: YES), the processor 51 may end the processing operation. In contrast, if the in-vehicle system is not stopped (Step S35: NO), the process may return to Step S25, and the processing in the steps described above may end.

As described above, the driving assistance apparatus 50 according to the example embodiment compares the information on the traveling state of the first vehicle (own vehicle 1) at the time of the determination as having the possibility of being tailgated by the following vehicle with the accumulated data on the traveling states of a plurality of second vehicles in the driving condition belonging to the same category as the driving condition of the first vehicle, to thereby determine the factor that provokes tailgating. Further, the driving assistance apparatus 50 presents the feedback information on the driving action of the driver of the own vehicle 1 on the basis of the determined factor.

The factor that provokes tailgating may be determined by comparing the information on the traveling state of the own vehicle 1 at the time of the determination as having the possibility of being tailgated by the following vehicle with the information on normal driving that does not provoke tailgating. Accordingly, it is possible to present the way of driving that does not provoke tailgating by the following vehicle on the basis of the data on the difference between the driving action of the driver of the own vehicle 1 and the driving action of the driver of another vehicle.

In one example where a driver who tends to drive a vehicle at a speed that he/she thinks is appropriate even when the inter-vehicle distance from the preceding vehicle is large drives a vehicle in an area with heavy traffic and vehicles traveling at relatively short inter-vehicle distances, the comment, “This is an area where vehicles are prone to travel at a relatively short inter-vehicle distance.” may be presented as the area characteristic, and the comment, “Be careful to drive at higher speed than usual or keep to the left lane as often as possible.” may be presented as the advice.

In another example where a driver who tends to drive a vehicle at a speed similar to those of other surrounding vehicles including vehicles traveling on an adjacent lane travels in an area including a road having two or more lanes and vehicles traveling at speeds largely different from those of the other vehicles traveling on an adjacent lane, the comment, “This is an area where vehicles tend to travel at speeds largely different from those of the other vehicles traveling on an adjacent lane.” may be presented as the area characteristic, and the comment “Be careful to sufficiently accelerate upon passing.” may be presented as the advice.

Accordingly, even when the driver drives the vehicle in a traveling area different from a usual area, the feedback information is presented on the basis of the factor that provokes tailgating specific to the traveling area. This helps prevent the vehicle from being tailgated by the other vehicle.

Further, the factor that provokes tailgating may be determined by comparing the data on the driving action that the driver of the own vehicle 1 took when the own vehicle 1 was determined as having the possibility of being tailgated by the following vehicle with the data on an appropriate driving action to be taken to avoid the tailgating. Accordingly, it is possible to present the way of driving that avoids tailgating or prevents the vehicle from being tailgated by another vehicle on the basis of the data on the difference between the driving action that the driver of the own vehicle 1 took and an appropriate driving action to be taken to avoid tailgating.

In one example where the vehicle travels in an area with a large number of single-lane roads and a small number of passing points, the appropriate driving action to be taken to avoid tailgating may be decelerating the vehicle to move to a road shoulder with a hazard light on. In this case, the comment, “This is an area with a small number of passing lanes.” may be presented as the area characteristic, and the comment, “The following vehicle is approaching. Turn on the hazard light and decelerate to move to a road shoulder in a straight region ahead to let the following vehicle overtake.” may be presented as the advice.

In one example where the vehicle travels in an area with a large number of lanes and a possibility of lane changing from an adjacent lane, the appropriate driving action to be taken to avoid tailgating may be keeping an inter-vehicle distance twice or more an usual distance. In this case, the comment, “This is an area where lane changing is often made” may be presented as the area characteristic, and the comment, “Keep a large inter-vehicle distance from the preceding vehicle to let other vehicles enter this lane easily.” may be presented as the advice.

Accordingly, even when the driver drives a vehicle in a traveling area different from a usual area, the feedback information is presented on the basis of the driving action to avoid tailgating specific to the traveling area. This allows the driver to take an appropriate driving action to immediately avoid tailgating when the vehicle of the driver has the possibility of being tailgated by the following vehicle.

As described above, the driving assistance apparatus 50 according to the example embodiment compares the information on the traveling state of the first vehicle (own vehicle 1) at the time of determination as having the possibility of being tailgated by the other vehicle (the third vehicle) with the accumulated data on the traveling states of the second vehicles in the driving condition belonging to the same category as the driving condition of the first vehicle, to thereby determine the factor that provokes tailgating, and presents the feedback information on the driving action of the driver of the own vehicle 1. Accordingly, it is possible to present appropriate advice in accordance with the driving characteristic of the driver of the own vehicle 1. This allows the driver of the own vehicle 1 to learn a driving skill to efficiently avoid tailgating.

Further, the driving assistance apparatus 50 according to at least one example embodiment may present advice on the avoidance action to take upon being tailgated and advice on the driving action to prevent tailgating. Accordingly, it is possible to present appropriate advice on a driving action that does not provoke tailgating in accordance with the driving characteristic of the driver of the own vehicle 1.

Further, the driving assistance apparatus 50 according to at least one example embodiment may present the feedback information together with the image data acquired before and after the time when the own vehicle 1 is determined as having the possibility of being tailgated by the following vehicle. In this case, the driving assistance apparatus 50 may switch the moving image patterns depending on the driving conditions or the factors that provoke tailgating. This allows the driver of the own vehicle 1 to efficiently recognize the factor that provokes tailgating.

Further, in a case where a record on the determination as having the possibility of being tailgated by the following vehicle is stored during the traveling of the own vehicle, the driving assistance apparatus 50 according to at least one example embodiment may present the feedback information after the driver completes driving of the own vehicle 1. Accordingly, it is possible to present the advice to the driver immediately after the occurrence of the driving condition in which the vehicle of the driver has the possibility of being tailgated. This helps prevent the driver from repeating the driving action that provokes tailgating.

Further, in a case where a destination is set to the navigation system 40, the driving assistance apparatus 50 according to at least one example embodiment may generate the drive plan so that the own vehicle 1 will not be tailgated by another vehicle on the way to the destination. For example, the drive plan that recommends changing the driver may be generated to avoid making each occupant take driving the occupant is not good at. Accordingly, it is possible to generate the traveling route schedule that minimizes the possibility of the own vehicle 1 being tailgated by the following vehicle.

Note that the processing from Step S121 to Step S129 described above may be executed in response to an input of a command signal on an external device communicable with the driving assistance apparatus 50 via wireless communication such as mobile communication. This allows the driving assistance apparatus 50 to be used as a learning device for improving a driving skill without being mounted in the own vehicle 1.

Although some example embodiments of the technology are described in detail above with reference to the accompanying drawings, the technology should not be limited to these examples. It is apparent that the persons skilled in the art of the field to which the technology belongs could have conceived of various changes and modifications of the technology within the scope of the concept of the technology described in claims, and these changes and modifications are considered to belong to the scope of the technology.

For example, all of the functions of the driving assistance apparatus 50 may be mounted on the own vehicle 1 in the example embodiments described above, this is a non-limiting example. For example, some of the functions of the driving assistance apparatus 50 may be implemented by a server apparatus communicable with the driving assistance apparatus 50 via mobile communication, and the driving assistance apparatus 50 may be configured to send and receive data to/from the server apparatus. Further, the driving assistance apparatus 50 may be a server apparatus communicable with in-vehicle devices such as a vehicle control apparatus, an HMI, or a head-mounted display.

In at least one example embodiment described above, the feedback information may be presented during, before, and after traveling of the own vehicle 1 on the basis of the results of the determination as to whether the own vehicle 1 has a possibility of being tailgated by another vehicle in view of the driving characteristics of the drivers of the other vehicles; however, the technology should not be limited to this example. For example, the feedback information may be used to determine whether switching to automatic driving is needed in a case where the driving condition of the own vehicle 1 is determined to make the driver of the other vehicle feel stressed on the basis of the results of the tailgating determination, for example. Alternatively, the feedback information may be used to learn the driving condition of the own vehicle 1 which does not make the driver of the other vehicle feel stressed and may be used as a criterion for setting the vehicle speed or other parameters of the own vehicle 1 for automatic driving control.

It is to be noted that the following aspects may also belong to the scope of the technology.

The driving assistance apparatus according to at least one of the example embodiments described above, in which the processor is configured to store the information on the factor that provokes tailgating and present the feedback information about the driving action after the completion of driving of the first vehicle in a case where the information on the factor that provokes tailgating is stored in the last driving.

The driving assistance apparatus according to at least one of the example embodiments described above, in which the processor is configured to store the information on the factor that provokes tailgating and set the traveling route to the destination on which the possibility that the own vehicle will be tailgated is minimized.

The driving assistance apparatus according to at least one of the example embodiments described above, in which the processor is configured to store the information on the factor that provokes tailgating together with the information on the traveling state of the first vehicle, and send the information on the factor that provokes tailgating and the information on the traveling state of the first vehicle that are stored in the processor to another device in response to a request for learning data from the other device.

The driving assistance apparatus according to at least one of the example embodiments described above, in which the processor is configured to store the information on the factor that provokes tailgating in association with the traveling area information, and present the feedback information about the driving action on the basis of the factor that provokes tailgating specific to the traveling area.

The driving assistance apparatus according to at least one of the example embodiments described above, in which the processor is configured to store the information on the fact that the own vehicle was tailgated, and present the feedback information about the driving action to avoid the tailgating after the completion of driving of the first vehicle in a case where the information on the fact that the own vehicle was tailgated is stored in the last driving.

The driving assistance apparatus according to at least one of the example embodiments described above, in which the processor is configured to store the information on the traveling states of the first vehicle detected before and after the first vehicle is determined as being tailgated by the other vehicle, and send the feedback information about the information on the traveling states of the first vehicle and the driving action to avoid the tailgating stored in the processor to another device in response to a request for learning data from the other device.

The driving assistance apparatus according to at least one of the example embodiments described above, in which the processor is configured to store the information on the traveling states of the first vehicle before and after the first vehicle is determined as being tailgated by the other vehicle in association with the traveling area information, and present the feedback information on the driving action to avoid the tailgating specific to the traveling area.

The driving assistance apparatus configured to assist driving of the first vehicle, the driving assistance apparatus including:
the acquisition unit configured to acquire the information on traveling states of the first vehicle and the information on a surrounding environment around the first vehicle;
the tailgating factor determination unit configured to determine a factor that provokes tailgating by comparing the information on the traveling states of the first vehicle with the accumulated data on traveling states of a plurality of second vehicles in a driving condition belonging to the same category as the driving condition of the first vehicle; and
the feedback presentation unit configured to present the feedback information about the driving action of the driver who drives the first vehicle on the basis of the factor that provokes tailgating.

The non-transitory computer readable medium containing a computer program to be adapted to the driving assistance apparatus configured to assist driving of the first vehicle, the computer program causing, when executed by at least one processor, the at least one processor to implement a method, the method including:
acquiring information on the traveling state of the first vehicle and the data on a surrounding environment of the first vehicle;
determine a factor that provokes tailgating by comparing the information on the traveling state of the first vehicle with accumulated data on traveling states of a plurality of second vehicles in a driving condition belonging to the same category as a driving condition of the first vehicle; and
presenting the feedback information about the driving action of the driver who drives the first vehicle on the basis of the factor that provokes the tailgating.

According to the example embodiments of the technology described above, it is possible to provide a driving action or a factor of the own vehicle that made the drivers of the other vehicles feel anxiety or stress and the way to improve the driving action to enhance the driving skill of the driver of the own vehicle.

The processor 51 in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 51. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 51.

1. A driving assistance apparatus configured to assist driving of a first vehicle, the driving assistance apparatus comprising:
at least one processor; and
at least one memory communicably coupled to the at least one processor, wherein
the at least one processor is configured to
acquire information on a traveling state of the first vehicle and information on a surrounding environment of the first vehicle,
determine a factor that provokes tailgating by comparing the information on the traveling state of the first vehicle with accumulated data on traveling states of second vehicles in a driving condition belonging to a same category as a driving condition of the first vehicle, and
present feedback information about a driving action of a driver who drives the first vehicle on a basis of the factor that provokes the tailgating.

2. The driving assistance apparatus according to claim 1, wherein the processor is configured to determine the factor that provokes the tailgating by comparing the information on the traveling state of the first vehicle with the accumulated data on the traveling states of the second vehicles traveling in a same traveling section as a traveling section of the first vehicle.

3. The driving assistance apparatus according to claim 1, wherein the processor is configured to determine the factor that provokes the tailgating by comparing the information on the traveling state of the first vehicle with the accumulated data on the traveling states of the second vehicles not being tailgated in the driving condition belonging to the same category as the driving condition of the first vehicle.

4. The driving assistance apparatus according to claim 1, wherein
the processor is further configured to
determine whether the first vehicle is being subjected to tailgating by a third vehicle traveling around the first vehicle,
compare the information on the traveling state of the first vehicle after being determined as being subjected to the tailgating with the accumulated data on the traveling states of the second vehicles subjected to the tailgating in the driving condition belonging to the same category as the driving condition of the first vehicle upon being determined as being subjected to the tailgating, and
present feedback information on an avoidance action to take after being subjected to the tailgating.

5. A non-transitory computer readable medium containing a computer program to be adapted to a driving assistance apparatus configured to assist driving of a first vehicle, the computer program causing, when executed by at least one processor, the at least one processor to implement a method, the method comprising:
acquiring information on a traveling state of the first vehicle and information on a surrounding environment of the first vehicle;
determine a factor that provokes tailgating by comparing the information on the traveling state of the first vehicle with accumulated data on traveling states of second vehicles in a driving condition belonging to a same category as a driving condition of the first vehicle; and
presenting feedback information about a driving action of a driver who drives the first vehicle on a basis of the factor that provokes the tailgating.
